(19) United States
(12) Patent Application Publication
(10) Pub. No.: US 2012/0058730 A1
(43) Pub. Date: Mar. 8, 2012

(54) MODULATION SWITCHING METHOD, TRANSMISSION STATION, AND RECEIVING STATION

(75) Inventors: Daisuke JITSUKAWA, Kawasaki (JP); Jianming WU, Kawasaki (JP)

(73) Assignee: FUJITSU LIMITED, Kawasaki-shi (JP)

(21) Appl. No.: 13/293,792

(22) Filed: Nov. 10, 2011

Related U.S. Application Data
(63) Continuation of application No. PCT/JP2009/059056, filed on May 15, 2009.

(51) Int. Cl. H04B 17/00; H04B 15/00

(52) U.S. Cl. 455/63.1; 455/67.11

(57) ABSTRACT

A modulation switching method performed in a radio communication system is disclosed. In the method, difference information between the first channel quality information fed back from the receiving station and second channel quality information used to determine a modulation method is generated and is sent as control information is sent to the receiving station, with the transmission station. Switch information from the difference information received as the control information and third channel quality information being previous information in the receiving station are acquired, and data signal is demodulated based on the switch information, with the receiving station.

### CROSS-REFERENCE TO RELATED APPLICATIONS

This application is a U.S. continuation application filed under 35 USC 111a and 365c of PCT application JP2009/059056, filed May 15, 2009. The foregoing application is hereby incorporated herein by reference.

### FIELD

The embodiments discussed herein are related to a modulation switching method in which a modulation method of a data signal is switched based on channel quality information, a transmission station, and a receiving station.

### BACKGROUND

Recently, digital communication systems such as HSPA (High Speed Packet Access), LTE (Long Term Evolution), and the like have been developed. For the HSPA, the LTE, or the like, a technology such as AMC (Adaptive Modulation and Coding scheme) or the like is applied to realize data transmission which is highly effective and highly reliable.

In the AMC, the MCS (Modulation and Coding Scheme) is conducted. That is, in a broad sense, control is conducted to switch a modulation method. In detail, the control switches a combination of the modulation method and a coding rate. By this control, it is possible to apply the MCS and improve data transmission efficiency while maintaining a receiving quality at a predetermined level.

In the above digital communication system, Japanese Laid-open Patent Publication No. 2007-288676discloses a technology in which a base station corrects a value of a feedback report received from a mobile station in response to an elapsed time from the report, and transmission allocation is controlled based on a corrected valued of the feedback report.

Also, Japanese Laid-open Patent Publication No. 2008-236018 discloses a technology in which the base station measures quality of a propagation path to the mobile station, sets a resource distribution of multiple control signals in a control resource based on the measured quality of the propagation path, and sends the resource distribution to the mobile station.

Control information transmitted from a transmission station by using the control signals is formed by elements such as the MCS. Since the control information is defined for each user, in accordance with increase of the number of control bits per user and the number of users, a radio resource available for sending a data signal is decreased, and transmission efficiency of the data signal is degraded.

### SUMMARY

According to an aspect of the embodiment, there is provided a modulation switching method performed in a radio communication system in which a modulation method for modulating a data signal is determined and switched based on first channel quality information fed back from a receiving station, and switch information for switching the modulation method of the data signal is sent from a transmission station to the receiving station, the modulation switching method including generating, with the transmission station, difference information between the first channel quality information fed back from the receiving station and second channel quality information used to determine the modulation method; sending, with the transmission station, the difference information as control information to the receiving station; acquiring, with the receiving station, the switch information from the difference information received as the control information and third channel quality information being previous information in the receiving station; and demodulating, with the receiving station, the data signal based on the switch information.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF THE DRAWINGS

FIG. 1 is a diagram illustrating a configuration example of a transmission station;

FIG. 2 is a diagram illustrating a configuration example of a receiving station;

FIG. 3 is a diagram illustrating a CQI table;

FIG. 4 is a diagram illustrating a TBS table;

FIG. 5 is a diagram illustrating an MCS table;

FIG. 6 is a diagram illustrating a transmission station in a first embodiment;

FIG. 7 is a diagram illustrating a receiving station in the first embodiment;

FIG. 8 is a diagram illustrating a transmission station in a second embodiment;

FIG. 9 is a diagram illustrating a receiving station in the second embodiment;

FIG. 10 is a diagram illustrating a difference CQI table;

FIG. 11 is a diagram illustrating a transmission station in a third embodiment;

FIG. 12 is a diagram illustrating a receiving station in the third embodiment;

FIG. 13 is a diagram illustrating a transmission station in a fourth embodiment;

FIG. 14 is a diagram illustrating a receiving station in the fourth embodiment;

FIG. 15 is a diagram illustrating a transmission station in a fifth embodiment; and

FIG. 16 is a diagram illustrating a receiving station in the fifth embodiment.

### DESCRIPTION OF EMBODIMENTS

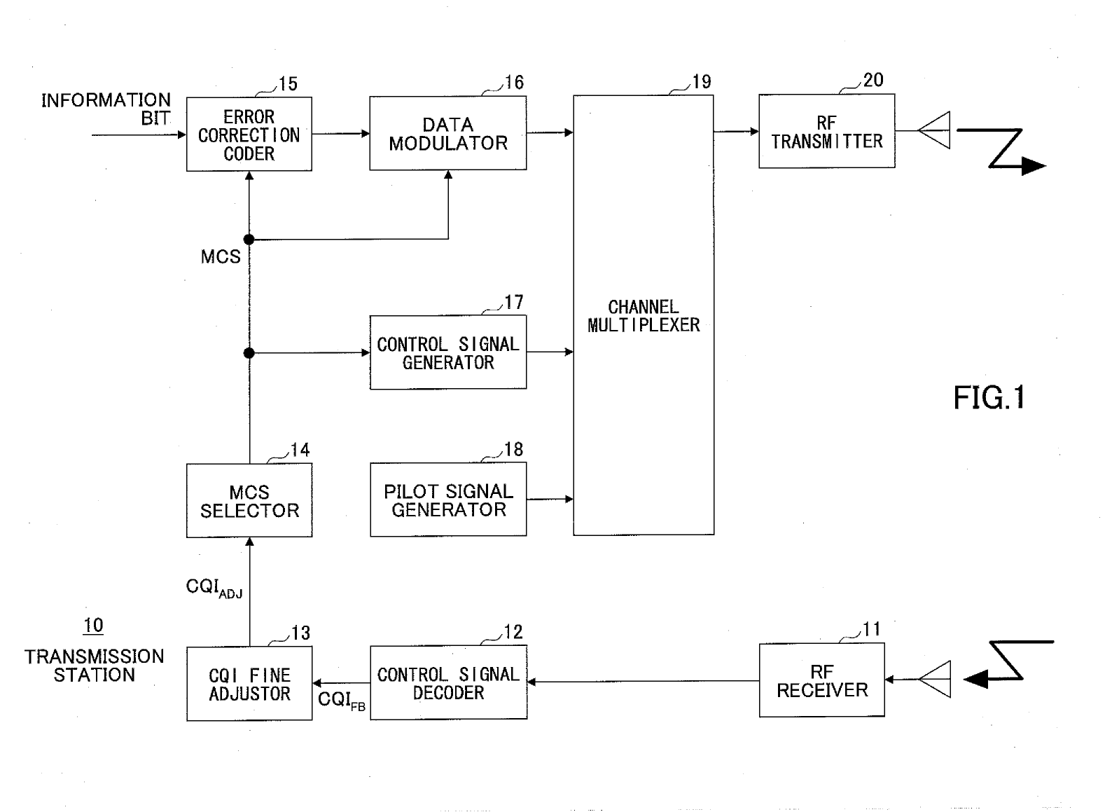

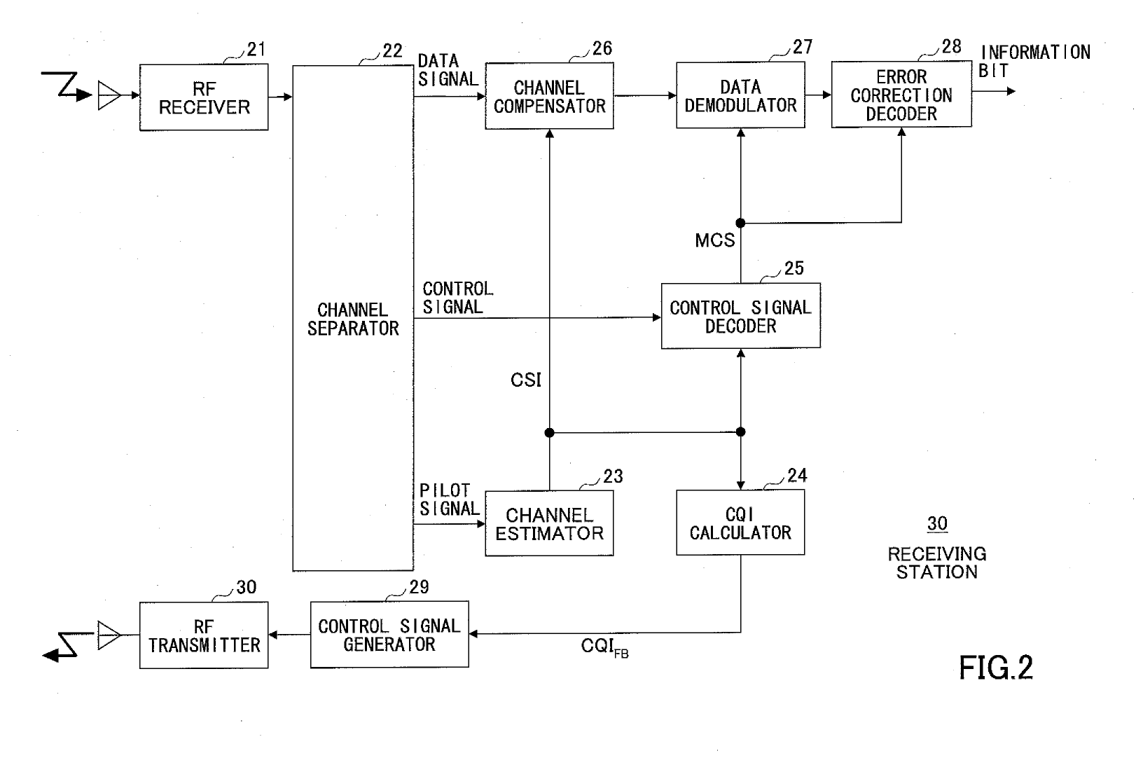

A configuration of a digital communication system using AMC (Adaptive Modulation and Coding scheme) will be described with reference to FIG. 1 and FIG. 2.

FIG. 1 is a diagram illustrating a configuration example of a transmission station 10. An RF receiver 11 receives a signal fed back from a receiving station 30 (FIG. 2), converts a radio frequency into a baseband, conducts quadrature demodulation and an A/D (analog to digital) conversion, and supplies a control signal decoder 12.

The control signal decoder 12 performs a decoding process for a control signal, extracts channel quality information (CQI) which indicates quality of a radio channel, and supplies the CQI to a CQI fine adjustor 13. The CQI is calculated based on SINR (Signal-to-Interference and Noise power Ratio) measured by the receiving station 30 (FIG. 2), so that BLER (BLock Error Rate) becomes 10% when the data signal of a transmission format corresponding to the CQI is received.

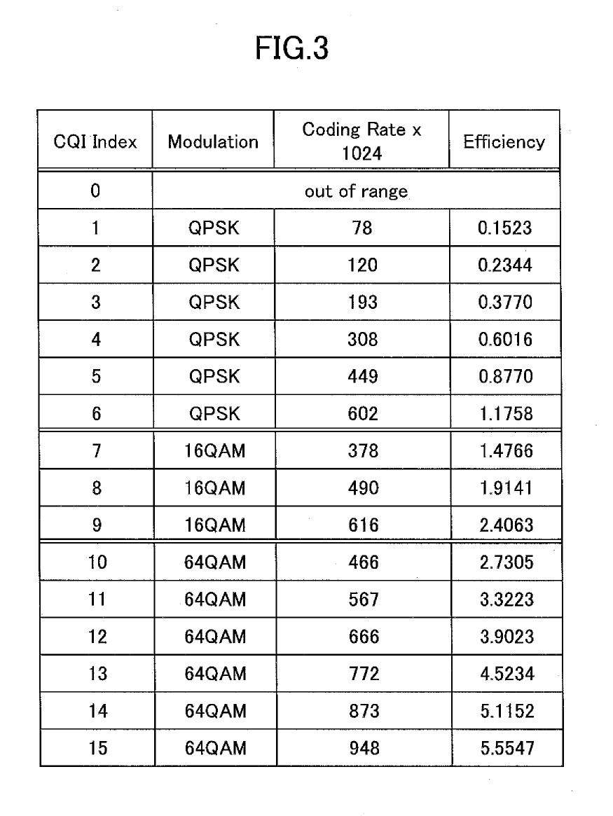

As indicated in a CQI table illustrated in FIG. 3, in LTE (Long Term Evolution), information bit number (Efficiency) may be indicated for each of 16 CQIs (CQI Indices) in which the information bit number (Efficiency) is transmitted by one modulation symbol with a modulation method (Modulation) and a coding rate (Coding Rate×1024). Hereinafter, the CQI fed back from the receiving station 30 (FIG. 2) is called CQI_{FB}.

The CQI fine adjustor 13 conducts a fine adjustment for the CQI_{FB} based on an independent determination, and outputs the CQI_{ADJ}. Specifically, first, the CQI fine adjustor 13 converts the CQI_{FB} into SINR (Signal-to-Interference and Noise power Ratio). Next, the CQI fine adjustor 13 averages the SINR in a time direction, and adjusts the SINR depending on a difference between a target BLER and an actual BLER. Then, the CQI fine adjustor 13 converts the SINR into CQI_{ADJ}.

The MCS selector 14 selects the MCS of the data signal, that is, a combination of the modulation method and the coding rate, based on the CQI_{ADJ}. 29 types of MCSs may be defined in the LTE, and one MCS is selected as described below.

The MCS selector 14 refers to the CQI table illustrated in FIG. 3, and acquires the modulation method (Modulation) and the information bit number (Efficiency) transmitted by one modulation symbol from CQI_{ADJ}. Also, by a scheduler (not shown), a resource block (Resource Block: RB) is determined as a frequency resource used to transmit the data signal.

Next, the MCS selector 14 calculates a tentative value of information bit number alternatively called TBS (Transport Block Size) by using the number of a RB and the information bit number (Efficiency). The TBS is regarded as a size transmitted in a sub-frame and as a time unit of the data transmission.

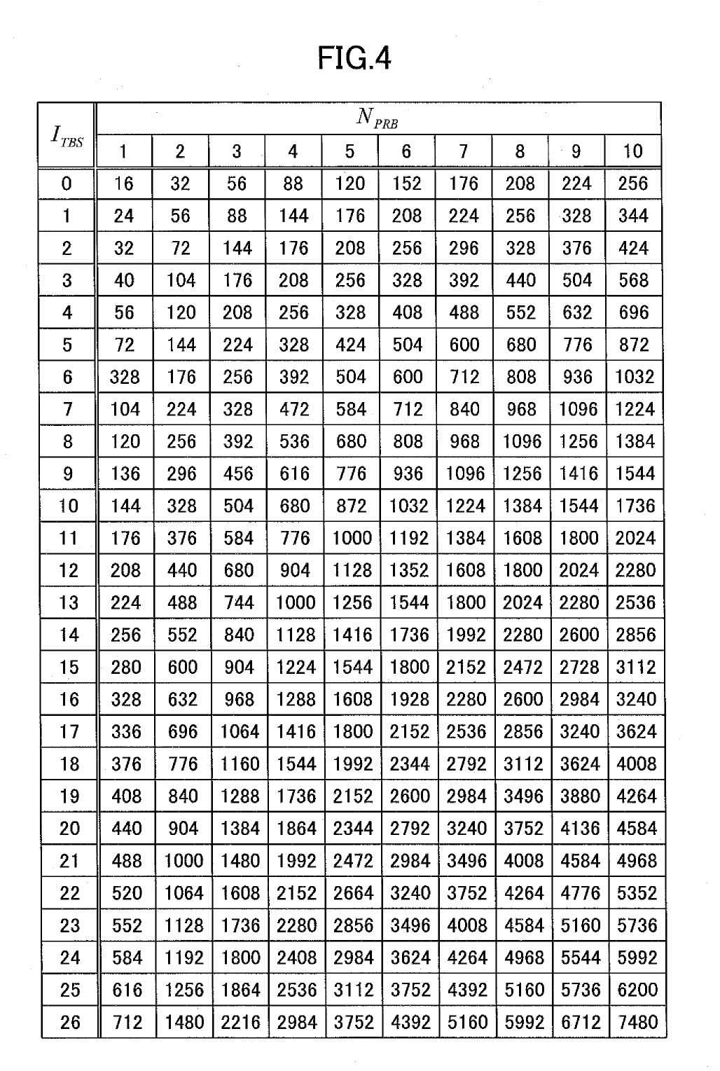

Also, a portion of a TBS table in the LTE, in which each of 0 to 26 candidates (I_{TBS}) (hereinafter, also called TBS indices) of the TBS are defined for 1 to 110 RBs (N_{PRB}), is illustrated in FIG. 4. The MCS selector 14 determines a value nearest to a temporary value of the TBS in the number of the RB (N_{PRB}) as a target TBS, and acquires a TBS index (I_{TBS}).

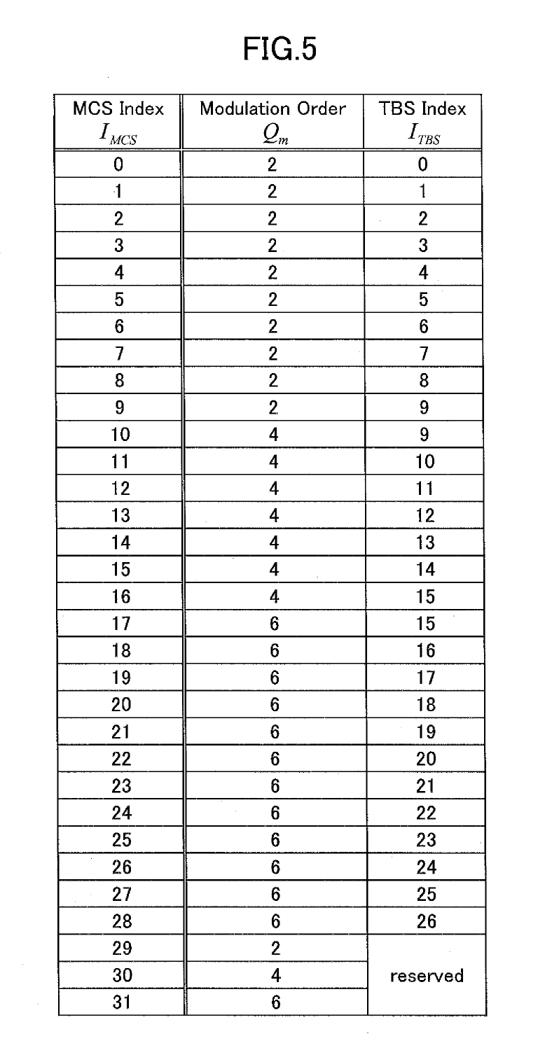

Also, in the LTE, as illustrated in a MCS table in FIG. 5, a modulation order (Qₘ) of a modulation method and the TBS index (I_{TBS}) correspond to each of 29 types (0 to 28) of MCS indices (I_{MCS}). The MCS selector 14 refers to the MCS table in FIG. 5, and acquires the MCS index (I_{MCS}) of 5 bits from the modulation order (Qₘ) and the TBS index (I_{TBS}). The MCS selector 14 supplies the MCS index (I_{MCS}) of 5 bits to an error correction coder 15, a data modulator 16, and a control signal generator 17.

The error correction coder 15 conducts an error correction coding for the data signal (information bit) so that the coding rate becomes a value indicated by the MCS. The data modulator 16 conducts data modulation by the modulation method indicated by the MCS.

The control signal generator 17 generates a control signal by conducting coding, the data modulation, and the like for control information included in the MCS. A pilot signal generator 18 generates a pilot signal for demodulating the data signal and the control signal at the receiving station and to measure the CQI. A channel multiplexer 19 multiplexes the data signal, the control signal, and the pilot signal, and generates a signal in a transmission form of a predetermined radio access method (OFDMA (Orthogonal Frequency Division Multiple Access) or the like). An RF transmitter 20 conducts a conversion from a baseband to the radio frequency by a D/A (Digital to Analog) conversion and a quadrature modulation, and sends a signal of the radio frequency to the receiving station 30.

FIG. 2 is a diagram illustrating a configuration example of the receiving station 30. An RF receiver 21 receives a signal sent from the transmission station 10 (FIG. 1), converts from the radio frequency to the baseband, conducts the quadrature demodulation and the A/D (Analog to Digital) conversion for the received signal, and supplies the received signal to a channel separator 22.

The channel separator 22 conducts a receiving process for a predetermined radio access method (OFDMA or the like). The receiving process may be an FFT (Fast Fourier Transform) timing detection, a GI (Guard Interval) elimination, and an FFT process in a case of the OFDMA. The channel separator 22 separates a received signal into a data signal, a control signal, and a pilot signal.

A channel estimator 23 calculates a correlation value between the pilot signal acquired by the channel separator 22 from the received signal and a known pilot signal, and thereby channel state information (CSI) of the radio channel represented by a complex number is estimated.

A CQI calculator 24 calculates the CQI based on a received SINR which is estimated by using the CSI. Specifically, as previously described, the CQI is calculated so that the BLER becomes 10% when the data signal of a transmission format corresponding to the CQI is received.

A control signal decoder 25 conducts a channel compensation by using the CSI provided from the channel estimator 23 for the control signal separated from the received signal by the channel separator 22, and further conducts data demodulation and an error correction decoding. Thus, the control information (including the MCS) is reproduced.

A channel compensator 26 conducts the channel compensation by using the CSI provided from the channel estimator 23 for the data signal separated from the received signal by the channel separator 22. A data demodulator 27 conducts the data demodulation by the modulation method which is indicated by the MCS and provided from the control signal decoder 25. An error correction decoder 28 conducts the error correction decoding for data demodulated by the data demodulator 27, with the coding rate which is indicated by the MCS and provided from the control signal decoder 25. Thus, a value of the information bit is reproduced and output from the error correction decoder 28.

A control signal generator 29 conducts the coding, the data modulation, and the like for the control information of the CQI_{FB} or the like which is regarded as the CQI and is provided from the CQI calculator 24, and thereby the control signal is generated. An RF transmitter 30 conducts the D/A conversion and the quadrature modulation for the control signal, converts from the baseband to the radio frequency, and sends a signal of the radio frequency to the transmission station 10.

Preferred embodiments of the present invention will be described with reference to accompanying drawings.

### [a] First Embodiment

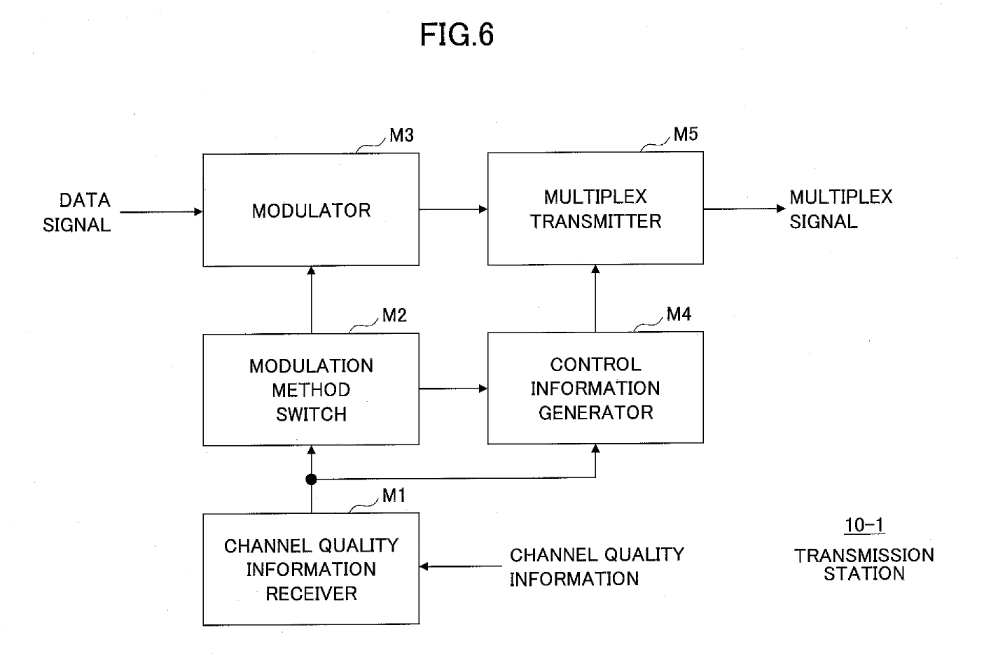

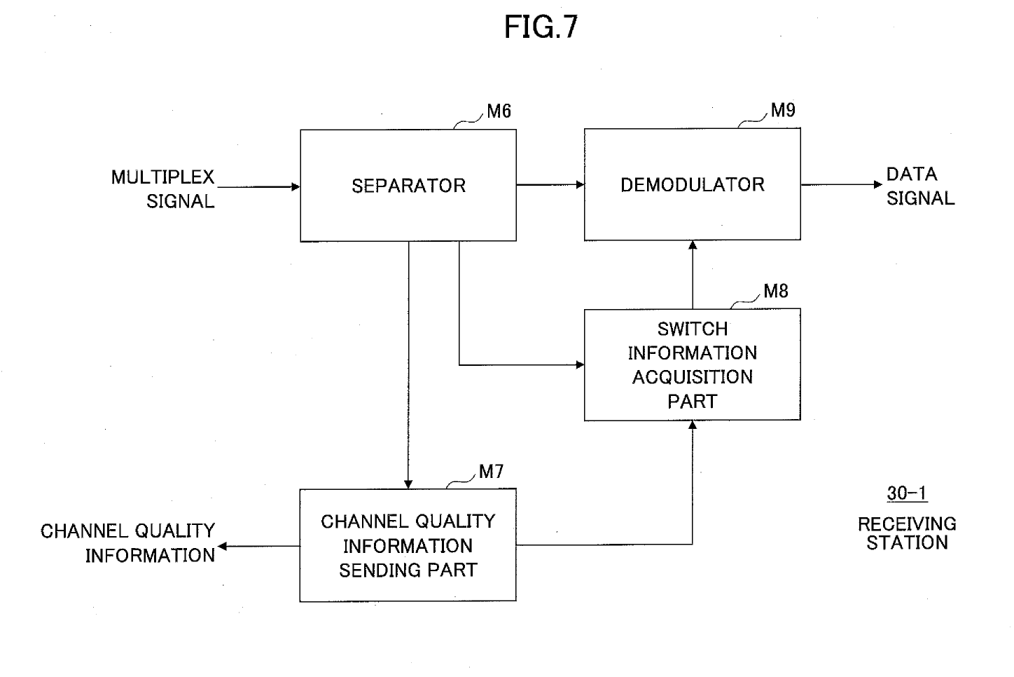

A configuration of a radio communication system using an AMC method in a first embodiment will be described with reference to FIG. 6 and FIG. 7.

<Transmission Station in First Embodiment>

FIG. 6 is a diagram illustrating a configuration of a transmission station 10-1 in the first embodiment. In FIG. 6, the transmission station 10-1 is illustrated as a radio transmission station. The transmission station 10-1 includes a channel quality information receiver M1, a modulation method switch M2, a modulator M3, a control information generator M4, and a multiplex transmitter M5. The channel quality information receiver M1 receives channel quality information which is fed back from a receiving station 30-1 in FIG. 7. The modulation method switch M2 determines the modulation method of the data signal based on the channel quality information received by the channel quality information receiver M1, and switches to the determined modulation method. The modulator M3 modulates the data signal by the modulation method which is switched by the modulation method switch M2.

The control information generator M4 generates difference information between channel quality information which is used by the modulation method switch M2 to determine the modulation method, and other channel quality information which is fed back from the receiving station 30-1 and is received by the channel quality information receiver M1. The multiplex transmitter M5 multiplexes the control information provided from the control information generator M4 with the modulated data signal and the pilot signal which are provided from the modulator M3, and sends the control information to the receiving station 30-1. The receiving station 30-1 is illustrated as a radio receiving station in FIG. 7.

<Receiving Station in First Embodiment>

FIG. 7 is a diagram illustrating a configuration of the receiving station 30-1 in the first embodiment. In FIG. 7, the receiving station 30-1 includes a separator M6, a channel quality information sending part M7, a demodulator M9, and a switch information acquisition part M8. The separator M6 receives a signal, in which the control information is multiplexed with the modulated data signal, from the transmission station 10-1 (FIG. 6). Then, the separator M6 separates the received signal into the control information, the modulated data signal, and the pilot signal. The channel quality information sending part M7 generates channel quality information of the radio channel transmitting the signal based on the pilot signal separated from the received signal by the separator M6, and sends the channel quality information to the transmission station 10-1 (FIG. 6).

The switch information acquisition part M8 acquires switch information from the difference information reported as the control information and previous channel quality information of the receiving station 30-1 itself. The demodulator M9 demodulates the modulated data signal separated by the separator M6, in response to the modulation method indicated in the switch information acquired by the switch information acquisition part M8.

In the first embodiment, instead of the switch information of the modulation method, the difference information, in which the bit number is less than that of the switch information, is transmitted from the transmission station 10-1 to the receiving station 30-1. Accordingly, it is possible to improve transmission efficiency of the data signal.

### [b] Second Embodiment

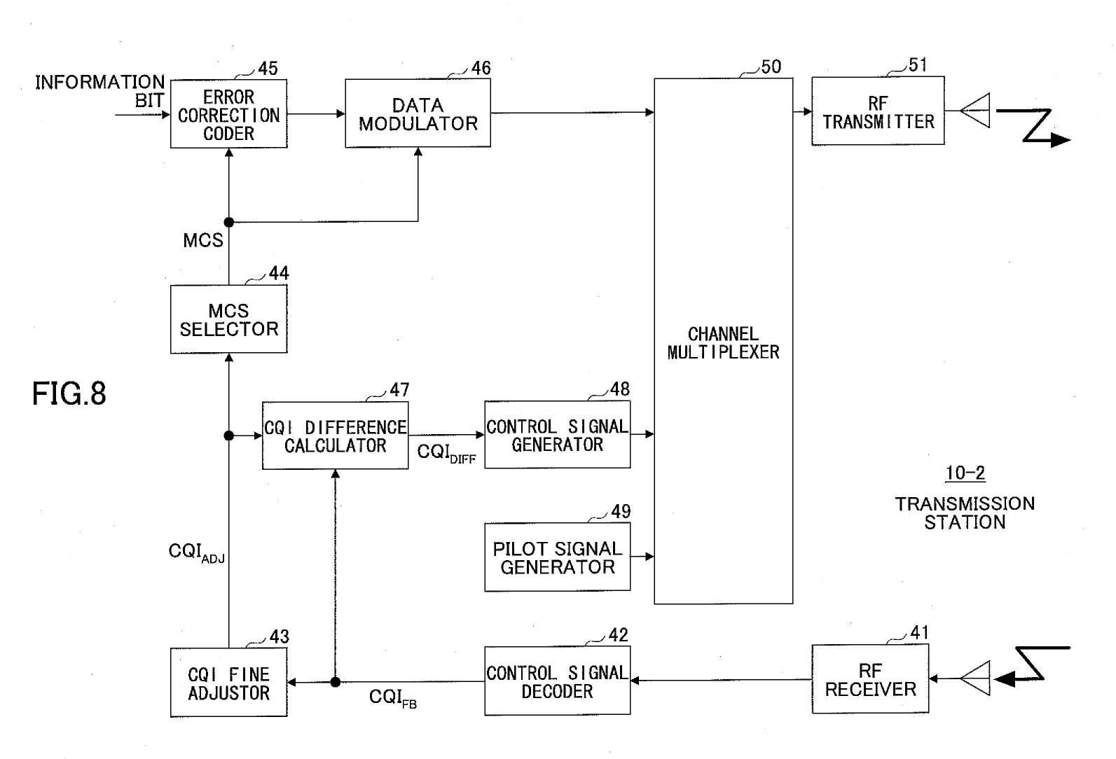

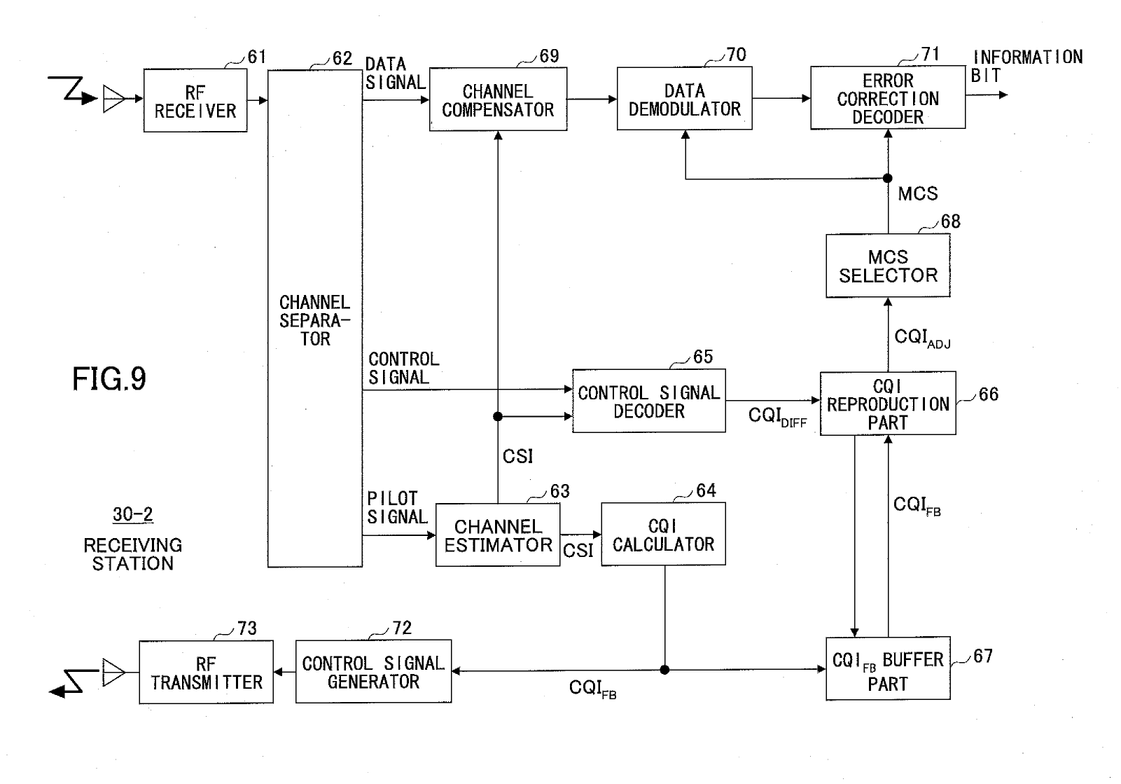

A configuration of a digital communication system using AMC will be described with reference to FIG. 8 and FIG. 9. In the second embodiment, a transmission station 10-2 in FIG. 8 may correspond to a radio base station, and a receiving station 30-2 in FIG. 9 may correspond to a mobile station.

<Transmission Station in Second Embodiment>

FIG. 8 is a diagram illustrating a configuration of the transmission station 10-2 in the second embodiment. In FIG. 8, the transmission station 10-2 includes an RF receiver 41, a control signal decoder 42, a CQI fine adjustor 43, an MCS selector 44, an error correction coder 45, a data modulator 46, a CQI difference calculator 47, a control signal generator 48, a pilot signal generator 49, a channel multiplexer 50, and an RF transmitter 51.

The RF receiver 41 receives a signal which is fed back from the receiving station 30-2. The RF receiver 41 converts from the radio frequency to the baseband, and conducts the quadrature demodulation and the A/D conversion, for the received signal. After that, the RF receiver 41 supplies the received signal to the control signal decoder 42.

The control signal decoder 42 extracts the channel quality information (CQI) indicating quality of the radio channel by performing a decoding process for the control signal. The CQI is calculated based on the received SINR measured by the receiving station 30-2, so that BLER (BLock Error Rate) becomes 10% when the data signal of a transmission format corresponding to the CQI is received.

As indicated in the CQI table in FIG. 3, in the LTE, information bit number (Efficiency) is indicated for each of 16 CQIs (CQI Indices) in which the information bit number (Efficiency) is transmitted by one modulation symbol with a modulation method (Modulation) and a coding rate (Coding Rate×1024). If CQI=1, the modulation method may be QPSK (Quadrature Phase Shift Keying), the coding rate may be 0.07617 (=78/1024), and the number of information bits, which are transmitted by one modulation symbol, may be 0.1523 (=0.07617×2). The control signal decoder 42 supplies the CQI_{FB}, which is fed back from the receiving station 30-2, to the CQI fine adjustor 43 and the CQI difference calculator 47.

The CQI fine adjustor 43 conducts the fine adjustment for the CQI_{FB} based on an independent determination, and outputs the CQI_{ADJ}. Specifically, first, the CQI fine adjustor 13 converts the CQI_{FB} into SINR (Signal-to-Interference and Noise power Ratio). Next, the CQI fine adjustor 13 averages the SINR in a time direction, and adjusts the SINR depending on a difference between a target BLER and an actual BLER. Then, the CQI fine adjustor 43 converts the SINR into CQI_{ADJ}.

The MCS selector 44 selects the MCS of the data signal based on the CQI_{ADJ}. The modulation method in a broad sense, that is, a combination of the modulation method and the coding rate in detail is selected. In the LTE, 29 types of the MCSs are defined. The MCS is selected as described below.

The MCS selector 44 refers to the CQI table illustrated in FIG. 3, and acquires the modulation method (Modulation) and the information bit number (Efficiency) from the CQI_{ADJ}. Also, by a scheduler (not shown), a resource block (Resource Block: RB) is determined as a frequency resource used to transmit the data signal.

Next, the MCS selector 44 calculates the temporary value of the information bit TBS which is regarded as a time unit and is transmitted in the sub-frame, by using the RB number and the information bit number.

Also, a portion of the TBS table in the LTE, in which each of 0 to 26 candidates (I_{TBS}) (TBS indices) of the TBS are defined for 1 to 110 RBs (N_{PRB}), is illustrated in FIG. 4. The MCS selector 44 determines a value nearest to a temporary value of the TBS in the number of the RB (N_{PRB}) as a target TBS, and acquires a TBS index (I_{TBS}).

Also, in the LTE, as illustrated in a MCS table in FIG. 5, a modulation order (Qₘ) of a modulation method and the TBS index (I_{TBS}) are corresponded to each of 29 types (0 to 28) of MCS indices (I_{MCS}). The MCS selector 44 refers to the MCS table in FIG. 5, and acquires the MCS index (I_{MCS}) of bits from the modulation order (Qₘ) and the TBS index (I_{TBS}). The MCS selector 44 supplies the MCS index (I_{MCS}) of 5 bits to an error correction coder 45, and a data modulator 46.

The error correction coder 45 conducts error correction coding for the data signal (information bits) so that the coding rate becomes a value indicated by the MCS. The data modulator 46 conducts data modulation by the modulation method indicated by the MCS.

The CQI difference calculator 47 calculates a difference between the CQI_{ADJ} after the fine adjustment is performed by the CQI fine adjustor 43 and the CQI_{FB} which is fed back most recently, and calculates information CQI_{DIFF} corresponding to the difference. The difference between the CQI_{ADJ} and the CQI_{FB} is related to a time jitter of the radio channel. Thus, the difference is sufficiently smaller than that in a definition region of the entire CQI.

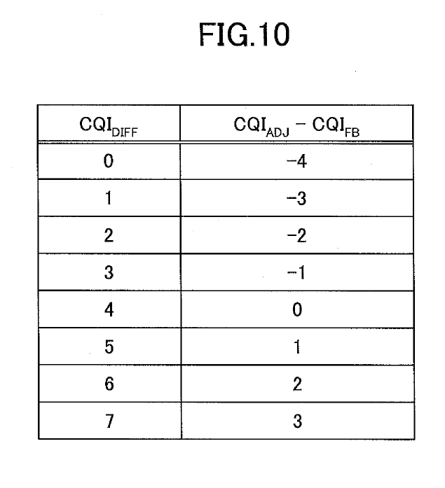

Accordingly, in a case of the LTE, with respect to the total 16 types of the CQIs, 8 types (3 bits) of CQI_{DIFF} may be defined as illustrated in a difference CQI table in FIG. 10. In this case, “CQI_{DIFF}=0” corresponds to “difference=−4”, “CQI_{DIFF}=4” corresponds to “difference=0”, and “CQI_{DIFF}=7” corresponds to “difference=3”. The CQI difference calculator 47 refers to the difference CQI table in FIG. 10 with a difference between the CQI_{ADJ} and the CQI_{FB}, and acquires the CQI_{DIFF} of 3 bits. Then, the CQI difference calculator 47 supplies the acquired the CQI_{DIFF} of 3 bits to the control signal generator 48.

In a related art case, the 29 types of the MCSs are sent by control bits (5 bits) to the receiving station 30. In the second embodiment, the CQI_{DIFF} is sent by the control bits (3 bits) to the receiving station 30-2. Therefore, it is possible to reduce the number of the control bits.

The control signal generator 48 generates the control signal by performing the coding, the data modulation, and the like for the control information such as the CQI_{DIFF}, or the like. The pilot signal generator 49 generates the pilot signal for the receiving station 30-2 to demodulate the data signal and the control signal and to measure the CQI. The channel multiplexer 50 multiplexes a data signal, a control signal, and the pilot signal, and generates a signal of a predetermined access method (OFDMA or the like). The RF transmitter 51 converts from the baseband to the radio frequency by conducting the D/A conversion and the quadrature modulation, and sends a signal of the radio frequency.

<Receiving Station in Second Embodiment>

FIG. 9 is a diagram illustrating a configuration of the receiving station 30-2 in the second embodiment. In FIG. 9, the receiving station 30-2 includes an RF receiver 61, a channel separator 62, a channel estimator 63, a CQI calculator 64, a control signal decoder 65, a CQI reproduction part 66, a CQI_{FB} buffer part 67, an MCS selector 68, a channel compensator 69, a data demodulator 70, an error correction decoder 71, a control signal generator 72, and an RF transmitter 73.

The RF receiver 61 receives a signal sent from the transmission station 10-2 (FIG. 8). The RF receiver 61 converts from the radio frequency to baseband and conducts the quadrature demodulation and the A/D conversion for the received signal. After that, the RF receiver 61 supplies the received signal to the channel separator 62.

The channel separator 62 conducts the receiving process for the predetermined radio access method (OFDMA or the like). The receiving process may be the FFT timing detection, a GI elimination, and an FFT process in a case of the OFDMA. The channel separator 62 separates a received signal into the data signal, the control signal, and the pilot signal.

The channel estimator 63 calculates the correlation value between the pilot signal acquired by the channel separator 62 from the received signal and the known pilot signal, thereby estimating the channel state information (CSI) of the radio channel represented by the complex number.

The CQI calculator 64 calculates the CQI based on the received SINR which is estimated by using the CSI. Specifically, as previously described, the CQI is calculated so that the BLER becomes 10% when the data signal of the transmission format corresponding to the CQI is received.

The control signal decoder 65 reproduces the control signal (including CQI_{DIFF}) and supplies CQI_{DIFF} to the CQI reproduction part 66.

On the other hand, the CQI, which is calculated by the CQI calculator 64, is supplied to the control signal generator 72 as the CQI_{FB} to be fed back to the transmission station 10-2, and is also additionally stored in the CQI_{FB} buffer part 67. The CQI reproduction part 66 refers to the difference CQI table in FIG. 10 by using the CQI_{DIFF} supplied from the control signal decoder 65, and acquires a difference (CQI_{ADJ}−CQI_{FB}) between the CQI_{ADJ} and CQI_{FB}.

The CQI reproduction part 66 reads out the CQI_{FB}, which has the same timing as the CQI_{FB} used to calculate CQI_{DIFF} at the transmission station 10-2, from the CQI_{FB} buffer part 67. The CQI reproduction part 66 acquires the CQI_{ADJ} by adding the difference (CQI_{ADJ}−CQI_{FB}) to the CQI_{FB} being read out, and supplies the CQI_{ADJ} to the MCS selector 68. The MCS selector 68 acquires the MCS from the CQI_{ADJ} in accordance with the same rule as the MCS selector 44 of the transmission station 10-2, and supplies the MCS to the data demodulator 70 and the error correction decoder 71.

The CQI reproduction part 66 recognizes a total process delay T_{PROC} related to the control signal generator 72, the RF transmitter 73, the RF receiver 61, the channel separator 62, and the control signal decoder 65 at the receiving station 30-2, and related to the RF receiver 41, the control signal decoder 42, the CQI difference calculator 47, the control signal generator 48, the channel multiplexer 50, and the RF transmitter 51 at the transmission station 10-2. The CQI reproduction part 66 reads out the CQI_{FB} before for the total process delay T_{PROC} from the CQI_{FB} buffer part 67 to synchronize timing for the CQI_{FB}. A propagation delay in the radio channel may not be a concern since the propagation delay is sufficiently smaller than a time unit for transmitting one packet.

The channel compensator 69 conducts the channel compensation by using the CSI provided from the channel estimator 63 with respect to the received data signal supplied from the channel separator 62. The data demodulator 70 conducts the data demodulation in accordance with the modulation method indicated by the MCS provided from the MCS selector 68. The error correction decoder 71 conducts the error correction decoding with respect to data demodulated by the data demodulator 70 by using the coding rate indicated by the MCS from the MCS selector 68, thereby reproducing and outputting the information bit.

The control signal generator 72 conducts the coding, the data modulation, and the like with respect to the control information such as the CQI_{FB}, or the like received from the CQI calculator 64. The RF transmitter 73 conducts the D/A conversion and the quadrature modulation for the control signal, converts from the baseband to the radio frequency, and sends a signal of the radio frequency to the transmission station 10-2.

As described above, even if the number of the control bits is reduced from 5 bits to 3 bits, it is possible for the receiving station 30-2 to recognize the MCS and to decode the data signal. Therefore, it is possible to reduce an overhead due to the control signal, suppress reduction of the radio resources usable for transmitting the data signal, and to suppress degradation of the transmission efficiency of the data signal.

### [c] Third Embodiment

In a system in which a frequency scheduling method such as the LTE is applied, the CQI may be defined for each of frequency sub-bands. The third embodiment suitable for this system will be described.

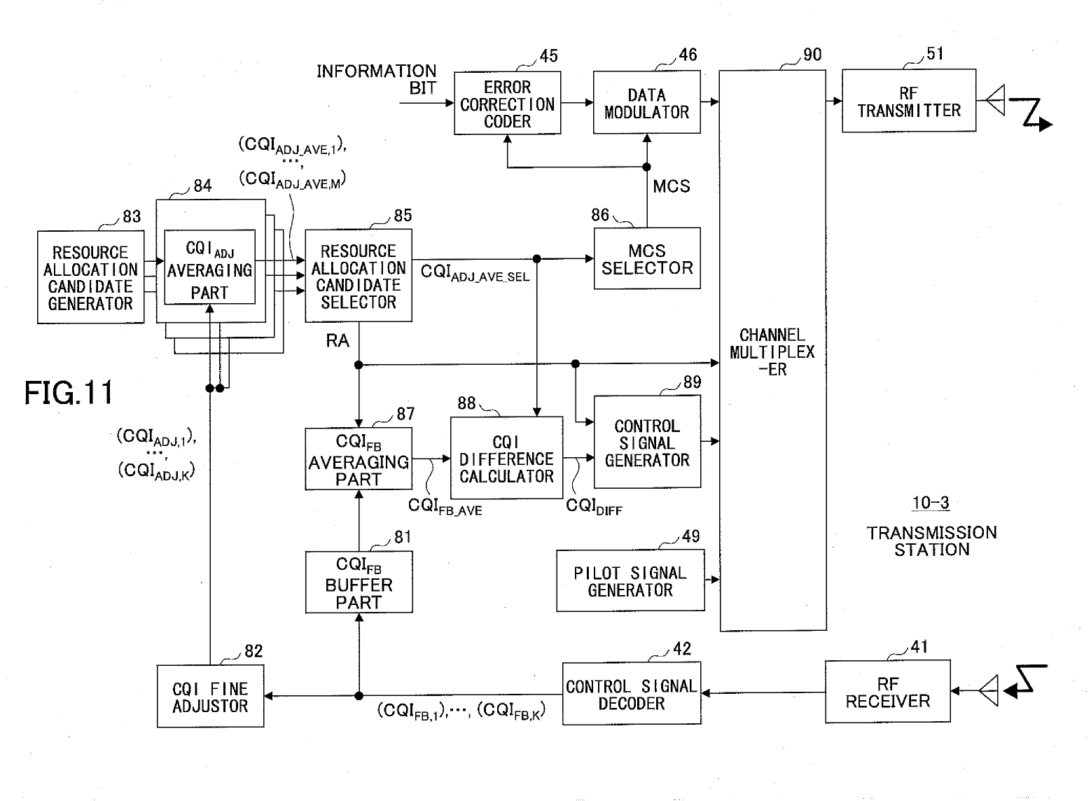

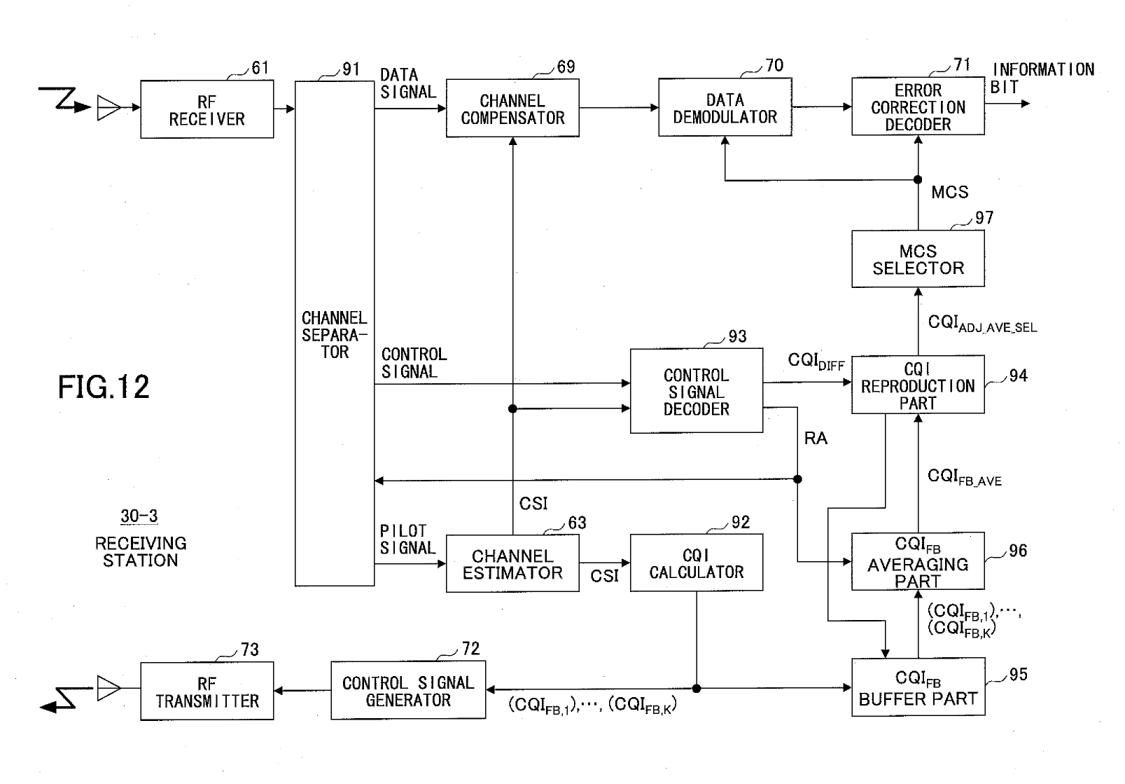

A configuration of the digital communication system using the AMC method in the third embodiment will be described with reference to FIG. 11 and FIG. 12. In the third embodiment, a transmission station 10-3 in FIG. 11 may correspond to the radio base station, and a receiving station 30-3 in FIG. 12 may correspond to the mobile station.

<Transmission Station in Third Embodiment>

FIG. 11 is a diagram illustrating a configuration of the transmission station 10-3 in the third embodiment. In FIG. 11, parts that are the same as those illustrated in FIG. 8 are given by the same reference numbers. The transmission station 10-3 includes the RF receiver 41, the control signal decoder 42, the error correction coder 45, the data modulator 46, the pilot signal generator 49, the RF transmitter 51, a CQI_{FB} buffer part 81, a CQI fine adjustor 82, a resource allocation candidate generator 83, a CQI_{ADJ} averaging part 84, a resource allocation candidate selector 85, a MCS selector 86, a CQI_{FB} averaging part 87, a CQI difference calculator 88, a control signal generator 89, and a channel multiplexer 90.

The RF receiver 41 receives a signal which is fed back from a receiving station 30-3 (FIG. 12). The RF receiver 41 converts from the radio frequency to the baseband, and conducts the quadrature demodulation and the A/D conversion, for the received signal. After that, the RF receiver 41 supplies the received signal to the control signal decoder 42.

The control signal decoder 42 conducts the decoding process for the control signal, and extracts the channel quality information (CQI) indicating quality of the radio channel.

In this case, a band in this system is divided into multiple frequency sub-bands. The CQI is defined for each of K frequency sub-bands. Each of K frequency sub-bands includes J resource blocks RB. K denotes an integer which is 2 or more. J denotes an integer which is 1 or more. The CQIs for K frequency sub-bands are individually called CQI_{FB,1}, . . . , CQI_{FB,K}. Then, by a single transmission from the receiving station 30-3, the CQI of all frequency sub-bands or the CQI of one or more frequency sub-bands in which the channel quality is preferable in all frequency sub-bands is fed back to the transmission station 10-3.

The CQI is calculated based on the received SINR which is measured at the receiving station 30-3, so that similar to the second embodiment, the BLER becomes 10% when the data signal of the transmission format corresponding to the CQI is received.

The control signal decoder 42 supplies the CQI_{FB,1}, . . . , CQI_{F3,K} which are fed back from the receiving station 30-3, to the CQI_{FB} buffer part 81, and the CQI fine adjustor 82. The latest CQI_{FB,1}, . . . , CQI_{FB,K} are additionally stored in the CQI_{FB} buffer part 81. The CQI fine adjustor 82 conducts the fine adjustment for each of K frequency sub-bands, similar to that conducted by the CQI fine adjustor 43 in the second embodiment. As a result, the CQI fine adjustor 82 supplies CQI_{ADJ,1}, . . . , CQI_{ADJ,K} to the averaging part 84.

The resource allocation candidate generator 83 generates M resource allocation candidates which are candidate patterns of the frequency sub-bands to be allocated for a next data transmission. M denotes a positive integer. The CQI_{ADJ} averaging part 84 averages, for each of M resource allocation candidates, values of the CQI (all or part of CQI_{ADJ,1}, . . . , CQI_{ADJ,K}) respective to the frequency sub-bands to be allocated for a data transmission. As a result, the CQI_{ADJ} averaging part 84 outputs CQI_{ADJ}_{_{—}}_{AVE,1}, . . . , CQI_{ADJ}_{_{—}}_{AVE,M}. An averaging method may be a method for converting CQI values into SINR values, averaging the SINR values, and converting to the CQI values, or the like.

The resource allocation candidate selector 85 selects one of M resource allocation candidates, and outputs resource allocation information RA corresponding to the selected resource allocation candidate and CQI_{ADJ}_{_{—}}_{AVE}_{_{—}}_{SEL} being an averaged CQI value. As a selection method, that is, as a scheduling algorithm, a method for selecting a resource allocation candidate in which the averaged CQI value is highest may be used.

The MCS selector 86 selects the MCS based on the CQI_{ADJ}_{_{—}}_{AVE}_{_{—}}_{SEL} provided from the resource allocation candidate selector 85, and supplies the selected MCS to the error correction coder 45 and the data modulator 46. A selection method may be similar to that conducted by the MCS selector 44 in the second embodiment.

The error correction coder 45 conducts the error correction coding with respect to the data signal so that the coding rate becomes a value indicated by the MCS. The data modulator 46 conducts the data modulation in accordance with the modulation method indicated by the MCS.

The CQI_{FB} averaging part 87 reads out the CQI values of one or more frequency sub-bands corresponding to the resource allocation information RA from the CQI_{FB} buffer part 81, and outputs CQI_{FB}_{_{—}}_{AVE} as a result of being averaged.

The CQI difference calculator 88 calculates a difference (CQI_{ADJ}_{_{—}}_{AVE}_{_{—}}_{SEL}−CQI_{FB}_{_{—}}_{AVE}) and acquires the information CQI_{DIFF} corresponding to the difference (CQI_{ADJ}_{_{—}}_{AVE}_{_{—}}_{SEL}−CQI_{FB}_{_{—}}_{AVE}). The CQI_{ADJ}_{_{—}}_{AVE}_{_{—}}_{SEL} is supplied from the resource allocation candidate selector 85 after the fine adjustment is conducted by the CQI fine adjustor 82, and the averaging is conducted for the frequency sub-bands by the CQI_{ADJ} averaging part 84. The CQI_{FB}_{_{—}}_{AVE} is supplied from the CQI_{FB} averaging part 87 after the averaging is conducted for the frequency sub-bands fed back from the receiving station 30-3. Similar to the second embodiment, the CQI difference calculator 88 may acquire the CQI_{DIFF} of 3 bits by referring to the difference CQI table in FIG. 10, and may supply the CQI_{DIFF} to the control signal generator 89.

The control signal generator 89 conducts the coding, the data modulation, and the like with respect to the control information including the CQI_{DIFF} and the resource allocation information RA, and generates the control signal. The pilot signal generator 49 generates the pilot signal for demodulating the data signal and the control signal, and to measure the CQI at the receiving station 30-3.

The channel multiplexer 90 generates the signal of the predetermined radio access method (OFDMA, or the like) by multiplexing the data signal, the control signal, and the pilot signal. The data signal is multiplexed with the frequency sub-band corresponding to the resource allocation information RA. The RF transmitter 51 performs a conversion from the baseband to the radio frequency by conducting the D/A conversion and the quadrature modulation, and sends a signal of the radio frequency.

In the third embodiment, the CQI_{DIFF} is reported as the control information with the resource allocation information RA, to the receiving station 30-3. Also, the CQI_{DIFF} may be sent by the control bits formed by 3 bits to the receiving station 30-3 in the third embodiment. Accordingly, it is possible to reduce the number of the control bits.

<Receiving Station in Third Embodiment>

FIG. 12 is a diagram illustrating a configuration of the receiving station 30-3 in the third embodiment. In FIG. 12, parts that are the same as those illustrated in FIG. are given by the same reference numbers. The receiving station 30-3 includes the RF receiver 61, the channel estimator 63, the channel compensator 69 the data demodulator 70, the error correction decoder 71, the control signal generator 72, the RF transmitter 73, a channel separator 91, a CQI calculator 92, a control signal decoder 93, a CQI reproduction part 94, a CQI_{FB} buffer part 95, a CQI_{FB} averaging part 96, and an MCS selector 97.

The RF receiver 61 receives a signal sent from the transmission station 10-3 (FIG. 11). The RF receiver 61 converts from the radio frequency to baseband and conducts the quadrature demodulation and the A/D conversion for the received signal. After that, the RF receiver 61 supplies the received signal to the channel separator 91.

The channel separator 91 conducts the receiving process for the predetermined radio access method (OFDMA or the like). The receiving process may be the FFT timing detection, the GI elimination, and the FFT process in the case of the OFDMA. The channel separator 91 separates the received signal into the data signal, the control signal, and the pilot signal. The data signal is acquired from the frequency sub-band indicated by the resource allocation information RA sent from the control signal decoder 93.

The channel estimator 63 calculates the correlation value between the pilot signal acquired by the channel separator 91 from the received signal and the known pilot signal, thereby estimating the channel state information (CSI) of the radio channel represented by the complex number.

The CQI calculator 92 calculates CQI (CQI_{FB,1}, . . . , CQI_{FB,K}) for each of the frequency sub-bands based on the received SINR estimated by using the CSI. Specifically, similar to the second embodiment, the CQI is calculated so that the BLER becomes 10% when the data signal of the transmission format corresponding to the CQI is received.

The control signal decoder 93 conducts the channel compensation by using the CSI provided from the channel estimator 63, and further conducts the data demodulation and the error correction decoding with respect to the received control signal provided from the channel separator 91, thereby reproducing the control information (RA, CQI_{DIFF}, or the like). The control signal decoder 93 supplies the CQI_{DIFF} to the CQI reproduction part 94, and supplies the resource allocation information RA to the channel separator 91 and the CQI_{FB} averaging part 96.

The CQI_{FB,1}, . . . , CQI_{FB,K}, which are calculated by the CQI calculator 92 for each of the frequency sub-bands, are supplied to the control signal generator 72 to feed back to the transmission station 10-3, and are also additionally stored in the CQI_{FB} buffer part 95.

The CQI reproduction part 94 reads out CQI_{FB,1}, . . . , CQI_{FB,K}, which have the same timings as the previously described CQI_{FB,1}, . . . , CQI_{FB,K} used when the CQI_{DIFF} is generated at the transmission station 10-3 and is supplied from the control signal decoder 93, from the CQI_{FB} buffer part 95.

Similar to the second embodiment, the CQI reproduction part 94 reads out the CQI_{FB} before for the total process delay T_{PROC} of the process delays at the receiving station 30-3 and the transmission station 10-3, from the CQI_{FB} buffer part 95 to synchronize timing for the CQI_{FB}.

The CQI_{FB} averaging part 96 averages the CQI_{FB,1}, . . . , CQI_{FB,K} read from the CQI_{FB} buffer part 95, for the frequency sub-bands corresponding to the resource allocation information RA supplied from the control signal decoder 93, and outputs the CQI_{FB}_{_{—}}_{AVE}.

The CQI reproduction part 94 refers to the difference CQI table in FIG. 10 by using the CQI_{DIFF} provided from the control signal decoder 93, and acquires the difference (CQI_{ADJ}_{_{—}}_{AVE}_{_{—}}_{SEL}−CQI_{FB}_{_{—}}_{AVE}). Next, the CQI reproduction part 94 adds the CQI_{FB}_{_{—}}_{AVE} acquired from the CQI_{FB} averaging part 96 to the difference (CQI_{ADJ}_{_{—}}_{AVE}_{_{—}}_{SEL}−CQI_{_{—}}_{AVE}), to acquire the CQI_{ADJ}_{_{—}}_{AVE}_{_{—}}_{SEL}.

The MCS selector 97 acquires the MCS from the CQI_{ADJ}_{_{—}}_{AVE}_{_{—}}_{SEL} in accordance with the same rule as that used by the MCS selector 86 in the transmission station 10-3 (FIG. 11).

The channel compensator 69 conducts the channel compensation by using the CSI provided from the channel estimator 63 with respect to the received data signal supplied from the channel separator 91. The data demodulator 70 conducts the data modulation in accordance with the modulation method indicated by the MCS provided from the MCS selector 97. The error correction decoder 71 conducts the error correction decoding with respect to data demodulated by the data demodulator 70, by using the coding rate indicated by the MCS provided from the MCS selector 97, to reproduce and output the information bits.

The control signal generator 72 conducts the coding, the data modulation, and the like with respect to the control information such as CQI_{FB,1}, . . . , CQI_{FB,K}, or the like for each of the frequency sub-bands provided from the CQI calculator 92, thereby generating the control signal. The RF transmitter 73 conducts the D/A conversion and the quadrature modulation for the control signal, converts from the baseband to the radio frequency, and sends the signal of the radio frequency to the transmission station 10-3.

Thus, even if the control bits are reduced from 5 bits to 3 bits, it is possible for the receiving station 30-3 to recognize the MCS without problem and to reproduce the data signal.

### [d] Fourth Embodiment

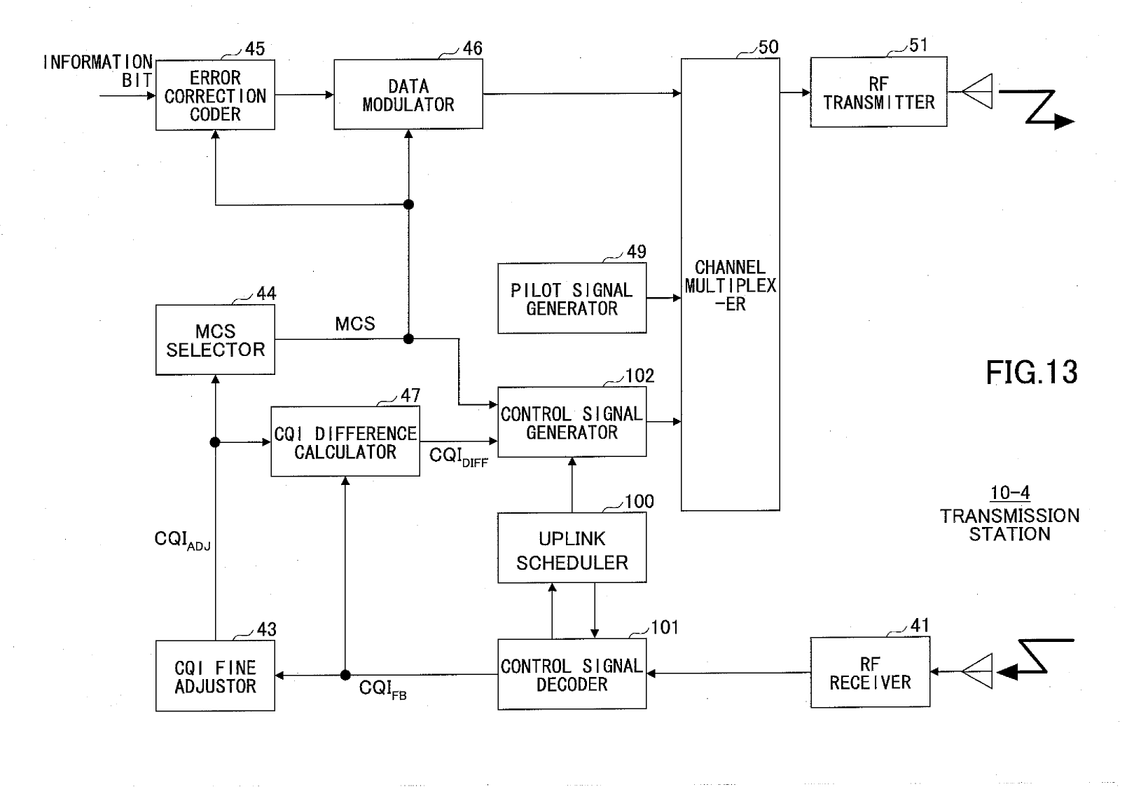

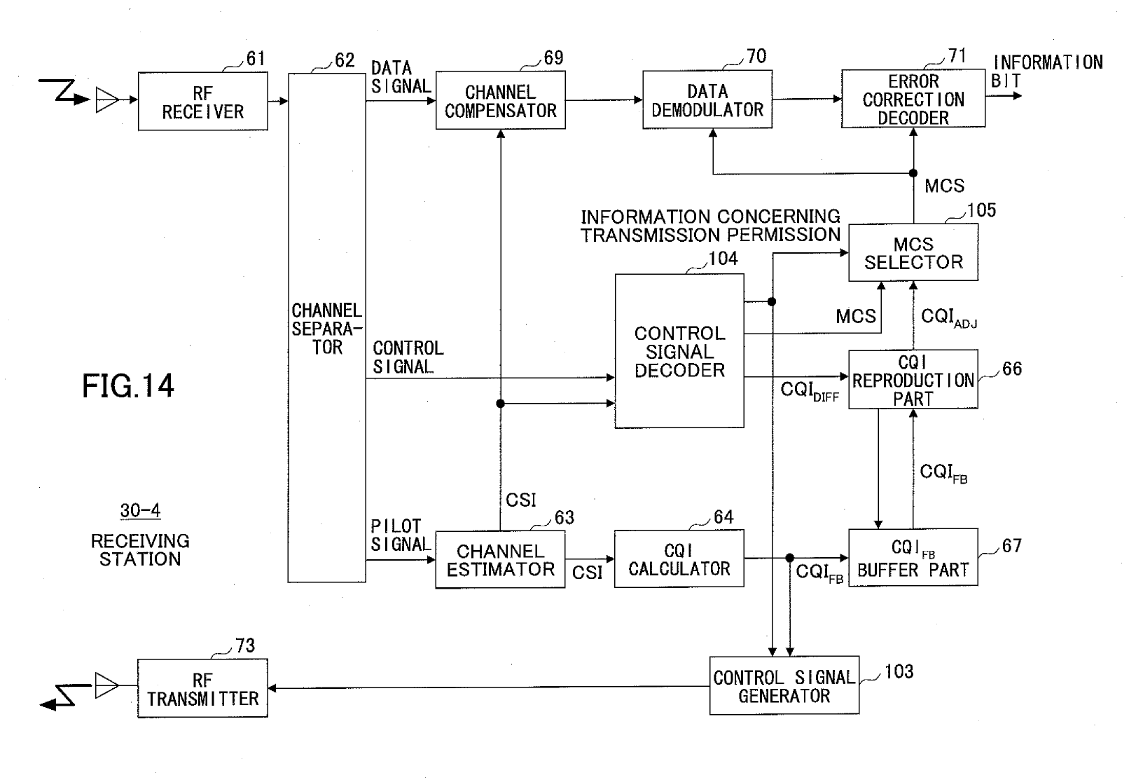

A fourth embodiment of the digital communication system, in which the AMC method is applied to an downlink of an LTE system, will be described with reference to FIG. 13 and FIG. 14. In the fourth embodiment, a transmission station 10-4 in FIG. 13 may correspond to the radio base station, and a receiving station 30-4 in FIG. 14 may correspond to the mobile station.

<Transmission Station in Fourth Embodiment>

FIG. 13 is a diagram illustrating a configuration of the transmission station 10-4 in the fourth embodiment. In FIG. 13, parts that are the same as those illustrated in FIG. 8 are given by the same reference numbers. The transmission station 10-3 includes the RF receiver 41, the CQI fine adjustor 43, the MCS selector 44, the error correction coder 45, the data modulator 46, the CQI difference calculator 47, the pilot signal generator 49, the channel multiplexer 50, the RF transmitter 51, an uplink scheduler 100, a control signal decoder 101, and a control signal generator 102.

The RF receiver 41 receives a signal which is fed back from the receiving station 30-4. The RF receiver 41 converts from the radio frequency to the baseband, and conducts the quadrature demodulation and the A/D conversion, for the received signal. After that, the RF receiver 41 supplies the received signal to the control signal decoder 101.

Considering quality of the radio channel, a transmission request received from the receiving station 30-4, and the like, the uplink scheduler 100 sends permission to transmit uplink data to the receiving station 30-4. The control signal decoder 101 decodes a signal received from the receiving station 30-4, and extracts uplink control information UCI including the CQI from the decoded signal.

In the LTE, the uplink control information (UCI) is transmitted by using one of a physical uplink shared channel (PUSCH) and a physical uplink control channel (PUCCH). Hereinafter, the physical uplink shared channel (PUSCH) is called “uplink shared channel PUSCH”, and the physical uplink control channel (PUCCH) is called “uplink control channel PUCCH”. That is, if there is the transmission permission of the uplink data, the uplink control information UCI is mapped to the uplink shared channel PUSCH with the uplink data, by additionally providing CRC (Cyclic Redundancy Check) bits for detecting an error. If there is not the transmission permission of the uplink data, the uplink control information UCI is mapped to the uplink control channel PUCCH without additionally providing the CRC bits.

The control signal decoder 101 decodes the uplink shared channel PUSCH or the uplink control channel PUCCH based on the transmission permission given by the uplink scheduler 100 before for time T₁, and extracts the CQI_{FB} from the uplink control information UCI. The time T₁ is regarded as a total of process delays of the control signal generator 102, the channel multiplexer 50, the RF transmitter 51, and the RF receiver 41 at the transmission station 10-4; and process delays of the RF receiver 61, the channel separator 62, a control signal decoder 104 (FIG. 14), a control signal generator 103 (FIG. 14), and the RF transmitter 73 at the receiving station 30-4. The control signal decoder 101 recognizes the time T.

When an error of the CQI_{FB} of the uplink shared channel PUSCH is detected, the control signal decoder 101 suppresses outputting the CQI_{FB}. On the other hand, when the error of the CQI_{FB} of the uplink shared channel PUSCH is not detected, or when the CQI_{FB} of the uplink control channel PUCCH is acquired, the control signal decoder 101 supplies the CQI_{FB} to the CQI fine adjustor 43 and the CQI difference calculator 47.

The CQI fine adjustor 43 conducts the fine adjustment for the CQI_{FB} based on an independent determination, and outputs the CQI_{ADJ}, similar to the second embodiment.

The MCS selector 44 selects the MCS of the data signal, that is, the combination of the modulation method and the coding rate based on the CQI_{ADJ}, and supplies the selected MCS to the error correction coder 45, the data modulator 46, and the control signal generator 102, similar to the second embodiment.

The error correction coder 45 conducts the error correction coding with respect to the data signal so that the coding rate becomes a value indicated by the MCS. The data modulator 46 conducts the data modulation in accordance with the modulation method indicated by the MCS.

The CQI difference calculator 47 calculates a difference between the CQI_{ADJ} after the fine adjustment is performed by the CQI fine adjustor 43 and the CQI_{FB} which is fed back most recently, calculates the information CQI_{DIFF} corresponding to the difference, and supplies the information CQI_{DIFF} to the control signal generator 102, similar to the second embodiment.

The control signal generator 102 generates the control signal by conducting the coding, the data modulation, and the like with respect to the control information such as information related to the transmission permission of the uplink data, the MCS, the CQI_{DIFF}, or the like. Reliability of the CQI_{DIFF} depends on reliability of the CQI_{FB}. In a case of transmitting the CQI_{FB} via the uplink shared channel PUSCH to the transmission station 10-4, it is possible to detect an error of the CQI_{FB} by using the CRC bits. In a case of detecting the error of the CQI_{FB} by the control signal decoder 101, the transmission station 10-4 conducts a control by the uplink scheduler 100 so as to suppress transmission of downlink data to the receiving station 30-4 as the mobile station. Therefore, a perception gap concerning the MCS may not occur between the transmission station 10-4 and the receiving station 30-4.

When the CQI_{FB} is transmitted via the uplink control channel PUCCH to the transmission station 10-4, the error of the CQI_{FB} may not be detected. Thus, if the transmission station 10-4 misdetermines the CQI_{FB}, the perception gap concerning the MCS may occur between the transmission station 10-4 and the receiving station 30-4.

The control signal generator 102 generates the control signal by selecting one of the CQI_{FB} and the MCS. Accordingly, in a first case where the CQI_{DIFF} is calculated based on the CQI_{FB} transmitted via the uplink shared channel PUSCH, the CQI_{DIFF} is reported to the receiving station 30-4. In a second case where the CQI_{DIFF} is calculated based on the CQI_{FB} transmitted via the uplink control channel PUCCH, the MCS itself is reported to the receiving station 30-4. It is possible for the control signal generator 102 to recognize the first case of reporting the CQI_{DIFF} to the receiving station 30-4 or the second case of reporting the MCS itself to the receiving station 30-4, from the transmission permission given by the uplink scheduler 100 before the time T₁. By the above described configuration, the perception gap concerning the MCS may not occur between the transmission station 10-4 and the receiving station 30-4.

The pilot signal generator 49 generates the pilot signal for demodulating the data signal and the control signal and to measure the CQI at the receiving station 30-4. The channel multiplexer 50 generates a signal of the predetermined radio access method (OFDMA or the like) by multiplexing the data signal, the control signal, and the pilot signal. The RF transmitter 51 converts from the baseband to the radio frequency by performing the D/A conversion and the quadrature modulation, and sends the signal of the radio frequency.

<Receiving Station in Fourth Embodiment>

FIG. 14 is a diagram illustrating a configuration of the receiving station 30-4 in the fourth embodiment. In FIG. 14, parts that are the same as those illustrated in FIG. are given by the same reference numbers. The receiving station 30-4 includes the RF receiver 61, the channel separator 62, the channel estimator 63, the CQI calculator 64, the CQI reproduction part 66, the CQI_{FB} buffer part 67, the channel compensator 69, the data demodulator 70, the error correction decoder 71, the RF transmitter 73, the control signal generator 103, a control signal decoder 104, and an MCS selector 105.

The RF receiver 61 receives a signal sent from the transmission station 10-4 (FIG. 13). The RF receiver 61 converts from the radio frequency to baseband and conducts the quadrature demodulation and the A/D conversion for the received signal. After that, the RF receiver 61 supplies the received signal to the channel separator 62.

The channel separator 62 conducts the receiving process for the predetermined radio access method (OFDMA or the like). The receiving process may be the FFT timing detection, the GI elimination, and the FFT process in the case of the OFDMA. The channel separator 62 separates the received signal into the data signal, the control signal, and the pilot signal.

The channel estimator 63 calculates the correlation value between the pilot signal acquired by the channel separator 62 from the received signal and the known pilot signal, thereby estimating the channel state information (CSI) of the radio channel represented by the complex number.

The CQI calculator 64 calculates the CQI based on the received SINR which is estimated by using the CSI, similar to the second embodiment. The CQI calculated by the CQI calculator 64 is supplied as the CQI_{FB} to be fed back to the transmission station 10-4 to the control signal generator 103 and is also additionally stored in the CQI_{FB} buffer part 67.

The control signal decoder 104 conducts the channel compensation by using the CSI provided from the channel estimator 63, and further conducts the data demodulation and the error correction decoding, with respect to the received control signal provided from the channel separator 62, thereby reproducing the control information. The control signal decoder 104 extracts information concerning the transmission permission of the uplink data from the reproduced control information. Also, by referring to the information concerning the transmission permission of time T₂ old (which is maintained in the control signal decoder 104), the control signal decoder 104 extracts either one of the CQI_{DIFF} and the MCS from the reproduced control information. If the information concerning the transmission permission of the time T₂ old indicates the transmission permission, the CQI_{DIFF} is extracted. If the information indicates transmission non-permission, the MCS is extracted.

The time T₂ is regarded as a total of process delays of the RF receiver 61, the channel separator 62, the control signal generator 103, and the RF transmitter 73 at the receiving station 30-4; and process delays of the RF receiver 41, the control signal decoder 101, the control signal generator 102, the channel multiplexer 50, and the RF transmitter 51 at the transmission station 10-4. The control signal decoder 104 recognizes the time T₂.

The control signal decoder 104 acquires the MCS when the CQI_{DIFF} is extracted, similar to the second embodiment. That is, the CQI reproduction part 66 refers to the difference CQI table in FIG. 10 by using the CQI_{DIFF} supplied from the control signal decoder 65, and acquires the difference (CQI_{ADJ}−CQI_{FB}) between the CQI_{ADJ} and the CQI_{FB}.

The CQI reproduction part 66 reads out CQI_{FB}, which is the same as the CQI_{FB} used to calculate the CQI_{DIFF} at the transmission station 10-4, from the CQI_{FB} buffer part 67, acquires the CQI_{ADJ} by adding the CQI_{FB} to the difference (CQI_{ADJ}−CQI_{FB}), and supplies the CQI_{ADJ} to the MCS selector 105. Similar to the second embodiment, the CQI reproduction part 66 reads out the CQI_{FB} before for the total process delay T_{PROC} of the process delays at the receiving station 30-3 and the transmission station 10-3, from the CQI_{FB} buffer part 95 to synchronize timing for the CQI_{FB}.

When the MCS is extracted by the control signal decoder 104, the control signal decoder 104 supplies the extracted MCS to the MCS selector 105.

The MCS selector 105 acquires the MCS from the CQI_{ADJ} in accordance with the same rule as the MCS selector 44 in the transmission station 10-4. Also, the MCS selector 105 selects the MCS acquired from CQI_{ADJ} supplied from the CQI reproduction part 66 if the information concerning the transmission permission before for the time T₂, which is supplied from the control signal decoder 104, indicates the transmission permission. The MCS selector 105 selects the MCS extracted by the control signal decoder 104 if the information indicates the transmission non-permission. Then, the MCS selector 105 supplies the selected MCS to the data demodulator 70 and the error correction decoder 71.

The channel compensator 69 conducts the channel compensation by using the CSI provided from the channel estimator 63 with respect to the received data signal supplied from the channel separator 62. The data demodulator 70 conducts the data demodulation in accordance with the modulation method indicated by the MCS provided from the MCS selector 105. The error correction decoder 71 conducts the error correction decoding for demodulated data received from the data demodulator 70, by using the coding rate indicated by the MCS supplied from the MCS selector 105, thereby reproducing the information bits. Then, the information bits are output from the error correction decoder 71.

The control signal generator 103 selects the uplink shared channel PUSCH when determining that a transmission is permitted based on the information concerning the transmission permission of the uplink data, the information being extracted by and supplied from the control signal decoder 104. The control signal generator 103 selects the uplink control channel PUCCH when determining that the transmission is not permitted based on the information concerning the transmission permission of the uplink data. After selecting one of the uplink shared channel PUSCH and the uplink control channel PUCCH, the control signal generator 103 generates the control signal by conducting the coding, the data modulation, and the like for the control information such as the CQI_{FB} or the like provided from the CQI calculator 64. The RF transmitter 73 conducts the D/A conversion and the quadrature modulation for the control signal, converts from the baseband to the radio frequency, and sends a signal of the radio frequency to the transmission station 10-4.

As described above, in a case of generating CQI_{DIFF} based on the CQI_{FB} transmitted via the uplink shared channel PUSCH, even if the number of the information bits is reduced, it is possible for the receiving station 30-4 to recognize the MCS and decode the data signal.

### [e] Fifth Embodiment

Next, a fifth embodiment, in which the CQI is defined for each of the frequency sub-bands, and the uplink control information UCI is transmitted via the uplink shared channel PUSCH or the uplink control channel PUCCH, will be described.

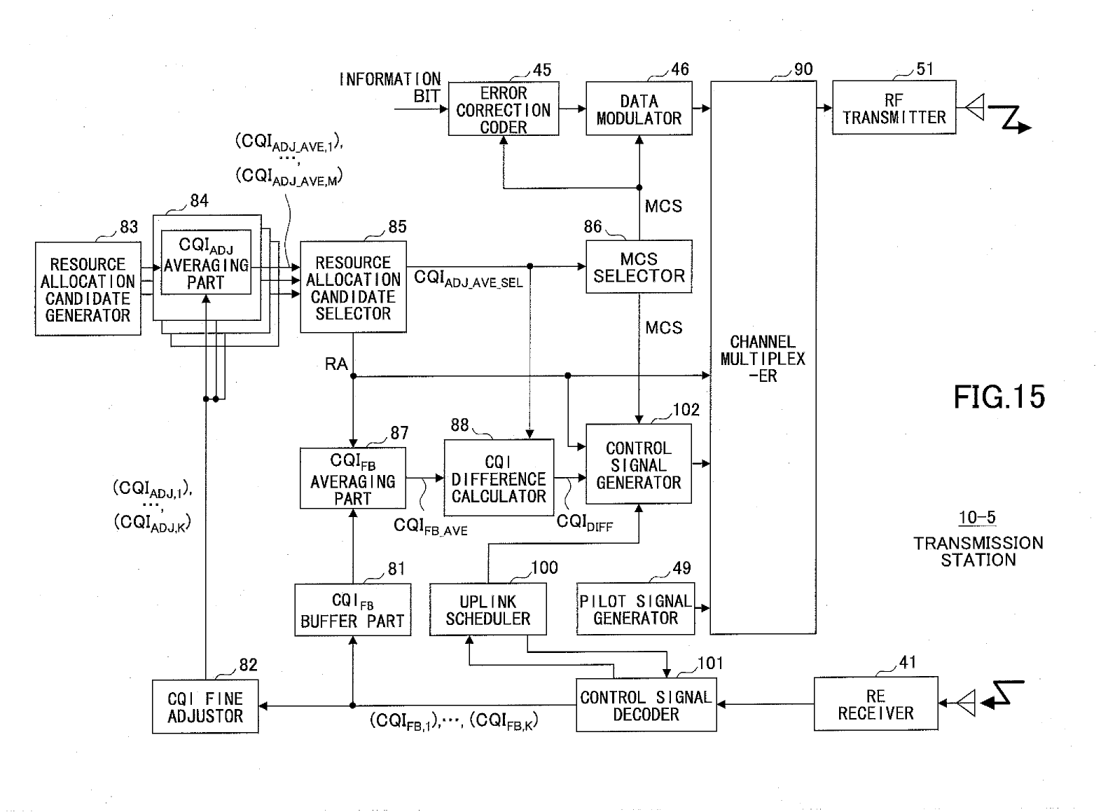

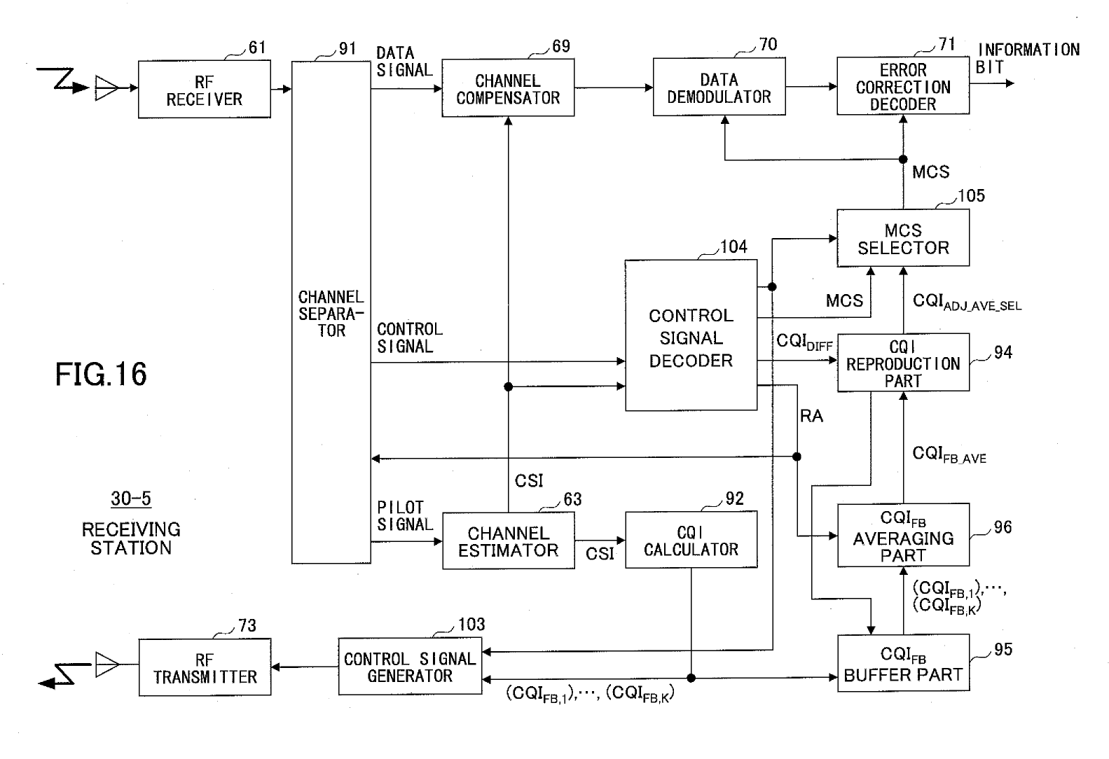

A configuration of the digital communication system using the AMC method in the fifth embodiment will be described with reference to FIG. 15 and FIG. 16. In the fifth embodiment, a transmission station 10-5 in FIG. 15 may correspond to the radio base station, and a receiving station 30-5 in FIG. 16 may correspond to the mobile station.

<Transmission Station in Fifth Embodiment>

FIG. 15 is a diagram illustrating a configuration of the transmission station 10-5 in the fifth embodiment. In FIG. 15, parts that are the same as those illustrated in FIG. 11 or FIG. 13 are given by the same reference numbers. The transmission station 10-5 includes the RF receiver 41, the error correction coder 45, the data modulator 46, the pilot signal generator 49, the RF transmitter 51, the CQI_{FB} buffer part 81, the CQI fine adjustor 82, the resource allocation candidate generator 83, the CQI_{ADJ} averaging part 84, the resource allocation candidate selector 85, the MCS selector 86, the CQI_{FB} averaging part 87, the CQI difference calculator 88, the channel multiplexer 90, the uplink scheduler 100, the control signal decoder 101, and a control signal generator 102.

The RF receiver 41 receives a signal which is fed back from the receiving station 30-5 (FIG. 16). The RF receiver 41 converts from the radio frequency to the baseband, and conducts the quadrature demodulation and the A/D conversion, for the received signal. After that, the RF receiver 41 supplies the received signal to the control signal decoder 101.

Considering the quality of the radio channel, a transmission request received from the receiving station 30-5, and the like, the uplink scheduler 100 sends a transmission permission of uplink data to the receiving station 30-5. The control signal decoder 101 decodes a signal received from the receiving station 30-5, and extracts the uplink control information UCI including the CQI from the decoded signal.

The CQI is defined for each of K frequency sub-bands. Each of K frequency sub-bands includes J resource blocks RB. K denotes an integer which is 2 or more. J denotes an integer which is 1 or more. The CQIs for K frequency sub-bands are individually called CQI_{FB,1}, . . . , CQI_{FB,K}. Then, by a single transmission from the receiving station 30-5, the CQI of all frequency sub-bands or the CQI of one or more frequency sub-bands in which the channel quality is preferable in all frequency sub-bands is fed back to the transmission station 10-5.

The CQI is calculated based on the received SINR which is measured at the receiving station 30-5, so that the BLER becomes 10% when the data signal of the transmission format corresponding to the CQI is received, similar to the second embodiment.

The control signal decoder 101 decodes the uplink shared channel PUSCH or the uplink control channel PUCCH based on the transmission permission given by the uplink scheduler 100 before for time T₁, and extracts the CQI_{FB} from the uplink control information UCI.

In a case in which the error of the CQI_{FB} of the uplink shared channel PUSCH is detected, the control signal decoder 101 outputs the CQI_{FB}. However, in another case, the control signal decoder 101 supplies CQI_{FB,1}, . . . , CQI_{FB,K}, which are fed back from the receiving station 30-5, to the CQI_{FB} buffer part 81 and the CQI fine adjustor 82. The latest CQI_{FB,1}, . . . , CQI_{FB,K} are additionally stored in the CQI_{FB} buffer part 81. The CQI fine adjustor 82 conducts the fine adjustment for each of K frequency sub-bands, similar to that conducted by the CQI fine adjustor 43 in the second embodiment. As a result, the CQI fine adjustor 82 supplies CQI_{ADJ,1}, . . . , CQI_{ADJ,K} to the averaging part 84.

The resource allocation candidate generator 83 generates the M resource allocation candidates which are candidate patterns of the frequency sub-bands to be allocated for a next data transmission. The CQI_{ADJ} averaging part 84 averages, for each of M resource allocation candidates, values of the CQI (all or part of CQI_{ADJ,1}, . . . , CQI_{ADJ,K}) respective to the frequency sub-bands to be allocated for the data transmission. As a result, the CQI_{ADJ} averaging part 84 outputs CQI_{ADJ}_{_{—}}_{AVE,1}, . . . , CQI_{ADJ}_{_{—}}_{AVE,M}. An averaging method may be a method for converting CQI values into SINR values, averaging the SINR values, and converting to the CQI values, or the like.

The resource allocation candidate selector 85 selects one of M resource allocation candidates, and outputs resource allocation information RA corresponding to the selected resource allocation candidate and CQI_{ADJ}_{_{—}}_{AVE}_{_{—}}_{SEL} being an averaged CQI value. As a selection method, that is, as a scheduling algorithm, a method for selecting a resource allocation candidate in which the averaged CQI value is highest may be used.

The MCS selector 86 selects the MCS based on the CQI_{ADJ}_{_{—}}_{AVE}_{_{—}}_{SEL} provided from the resource allocation candidate selector 85, and supplies the selected MCS to the error correction coder 45 and the data modulator 46. A selection method may be similar to that conducted by the MCS selector 44 in the second embodiment.

The error correction coder 45 conducts the error correction coding with respect to the data signal so that the coding rate becomes a value indicated by the MCS. The data modulator 46 conducts the data modulation in accordance with the modulation method indicated by the MCS.

The CQI_{FB} averaging part 87 reads out the CQI value of the frequency sub-band corresponding to the resource allocation information RA from the CQI_{FB} buffer part 81, and outputs CQI_{FB}_{_{—}}_{AVE} as a result of being averaged.

The CQI difference calculator 88 calculates a difference (CQI_{ADJ}_{_{—}}_{AVE}_{_{—}}_{SEL}−CQI_{FB}_{_{—}}_{AVE}) and acquires the information CQI_{DIFF} corresponding to the difference (CQI_{ADJ}_{_{—}}_{AVE}_{_{—}}_{SEL}−CQI_{FB}_{_{—}}_{AVE}). The CQI_{ADJ}_{_{—}}_{AVE}_{_{—}}_{SEL} is supplied from the resource allocation candidate selector 85 after the fine adjustment is conducted by the CQI fine adjustor 82, and the averaging is conducted for the frequency sub-bands by the CQI_{ADJ} averaging part 84. The CQI_{FB}_{_{—}}_{AVE} is supplied from the CQI_{FB} averaging part 87 after the averaging is conducted for the frequency sub-bands fed back from the receiving station 30-5. Similar to the second embodiment, the CQI difference calculator 88 may acquire the CQI_{DIFF} of 3 bits by referring to the difference CQI table in FIG. 10, and may supply the CQI_{DIFF} to the control signal generator 102.

The control signal generator 102 generates the control signal by conducting the coding, the data modulation, and the like with respect to the control information such as information related to the transmission permission of the uplink data, the MCS, the CQI_{DIFF}, or the like. Reliability of the CQI_{DIFF} depends on reliability of the CQI_{FB}. In a case of transmitting the CQI_{FB} via the uplink shared channel PUSCH to the transmission station 10-5, it is possible to detect an error of the CQI_{FB} by using the CRC bits. In a case of detecting the error of the CQI_{FB} by the control signal decoder 101, the transmission station 10-5 conducts a control by the uplink scheduler 100 so as to suppress transmission of downlink data to the receiving station 30-5 as the mobile station. Therefore, a perception gap concerning the MCS may not occur between the transmission station 10-5 and the receiving station 30-5.

When the CQI_{FB} is transmitted via the uplink control channel PUCCH to the transmission station 10-5, the error of the CQI_{FB} may not be detected. Thus, if the transmission station 10-5 misdetermines the CQI_{FB}, the perception gap concerning the MCS may occur between the transmission station 10-5 and the receiving station 30-5.

The control signal generator 102 generates the control signal by selecting one of the CQI_{FB} and the MCS. Accordingly, in a first case where the CQI_{DIFF} is calculated based on the CQI_{FB} transmitted via the uplink shared channel PUSCH, the CQI_{DIFF} is reported to the receiving station 30-5. In a second case where the CQI_{DIFF} is calculated based on the CQI_{FB} transmitted via the uplink control channel PUCCH, the MCS itself is reported to the receiving station 30-5. It is possible for the control signal generator 102 to recognize the first case of reporting the CQI_{DIFF} to the receiving station 30-5 or the second case of reporting the MCS itself to the receiving station 30-5, from the transmission permission given by the uplink scheduler 100 before the time T₁. By the above described configuration, the perception gap concerning the MCS may not occur between the transmission station 10-5 and the receiving station 30-5.

The pilot signal generator 49 generates the pilot signal for demodulating the data signal and the control signal and to measure the CQI at the receiving station 30-5. The channel multiplexer 90 generates the signal of the predetermined radio access method (OFDMA or the like) by multiplexing the data signal, the control signal, and the pilot signal. The data signal is multiplexed with the frequency sub-bands corresponding to the resource allocation information RA. The RF transmitter 51 converts from the baseband to the radio frequency by performing the D/A conversion and the quadrature modulation, and sends the signal of the radio frequency.

In the fifth embodiment, the CQI_{DIFF} is reported as the control information with the resource allocation information RA, to the receiving station 30-5. Also, the CQI_{DIFF} may be sent by the control bits formed by 3 bits to the receiving station 30-5 in the third embodiment. Accordingly, it is possible to reduce the number of the control bits.

<Receiving Station in Fifth Embodiment>

FIG. 16 is a diagram illustrating a configuration of the receiving station 30-5 in the fifth embodiment. In FIG. 16, parts that are the same as those illustrated in FIG. 12 or FIG. 14 are given by the same reference numbers. The receiving station 30-5 includes the RF receiver 61, the channel estimator 63, the channel compensator 69, the data demodulator 70, the error correction decoder 71, the RF transmitter 73, the channel separator 91, the CQI calculator 92, the CQI reproduction part 94, the CQI_{FB} buffer part 95, the CQI_{FB} averaging part 96, the control signal generator 103, the control signal decoder 104, and the MCS selector 105.

The RF receiver 61 receives a signal sent from the transmission station 10-5 (FIG. 15). The RF receiver 61 converts from the radio frequency to baseband and conducts the quadrature demodulation and the A/D conversion for the received signal. After that, the RF receiver 61 supplies the received signal to the channel separator 91.

The channel separator 91 conducts the receiving process for the predetermined radio access method (OFDMA or the like). The channel separator 91 separates the received signal into the data signal, the control signal, and the pilot signal. The data signal is acquired from the frequency sub-band indicated by the resource allocation information RA sent from the control signal decoder 104.

The channel estimator 63 calculates the correlation value between the pilot signal acquired by the channel separator 91 from the received signal and the known pilot signal, thereby estimating the channel state information (CSI) of the radio channel represented by the complex number.

The CQI calculator 92 calculates CQI (CQI_{FB,1}, . . . , CQI_{FB,K}) for each of the frequency sub-bands based on the received SINR estimated by using the CSI. Specifically, similar to the second embodiment, the CQI is calculated so that the BLER becomes 10% when the data signal of the transmission format corresponding to the CQI is received.

The control signal decoder 104 conducts the channel compensation by using the CSI provided from the channel estimator 63, and further conducts the data demodulation and the error correction decoding, with respect to the received control signal provided from the channel separator 91. By theses operations, the control signal decoder 104 reproduces the control information (RA, CQI_{DIFF}, the information concerning the transmission permission of the uplink data, or the like), supplies the CQI_{DIFF} to the CQI reproduction part 94, and supplies the resource allocation information RA to the channel separator 91 and the CQI_{FB} averaging part 96. In addition, the control signal decoder 104 extracts the information concerning the transmission permission of the uplink data to the control signal generator 103. Also, by referring to the information concerning the transmission permission of time T₂ before (which is maintained in the control signal decoder 104), the control signal decoder 104 extracts one of the CQI_{DIFF} and the MCS from the reproduced control information. If the information concerning the transmission permission of the time T₂ old indicates the transmission permission, the CQI_{DIFF} is extracted. If the information indicates transmission non-permission, the MCS is extracted.

CQI_{FB,1}, . . . , CQI_{FB,K} for each of the frequency sub-bands, which are calculated by the CQI calculator 92, are supplied to the control signal generator 103 in order to be fed back to the transmission station 10-5, and are also additionally stored in the CQI_{FB} buffer part 95.

The CQI reproduction part 94 reads out CQI_{FB,1}, . . . , CQI_{FB,K}, which have the same timings as the CQI_{FB,1}, . . . , CQI_{FB,K} used when the CQI_{DIFF} is generated at the transmission station 10-5 and is supplied from the control signal decoder 104, from the CQI_{FB} buffer part 95.

Similar to the second embodiment, the CQI reproduction part 94 reads out the CQI_{FB} before for the total process delay T_{PROC} of the process delays at the receiving station 30-5 and the transmission station 10-5, from the CQI_{FB} buffer part 95 to synchronize timing for the CQI_{FB}.

The CQI_{FB} averaging part 96 averages the CQI_{FB,1}, . . . , CQI_{FB,K} extracted from the CQI_{FB} buffer part 95 for the frequency sub-bands corresponding to the resource allocation information RA provided from the control signal decoder 104, and outputs the CQI_{FB}_{_{—}}_{AVE}.

The CQI reproduction part 94 refers to the difference CQI table in FIG. 10 by using the CQI_{DIFF} supplied from the control signal decoder 104, thereby acquiring the difference (CQI_{ADJ}_{_{—}}_{AVE}_{_{—}}_{SEL}−CQI_{FB}_{_{—}}_{AVE}). Next, the CQI reproduction part 94 acquires the CQI_{ADJ}_{_{—}}_{AVE}_{_{—}}_{SEL} by adding the CQI_{FB}_{_{—}}_{AVE} acquired from the CQI_{FB} averaging part 96 to the difference (CQI_{ADJ}_{_{—}}_{AVE}_{_{—}}_{SEL}−CQI_{FB}_{_{—}}_{AVE})

When the control signal decoder 104 extracts the MCS, the control signal decoder 104 supplies the extracted MCS to the MCS selector 105.

The MCS selector 105 acquires the MCS from the CQI_{ADJ}_{_{—}}_{AVE}_{_{—}}_{SEL} in accordance with the same rule as the MCS selector 86 in the transmission station 10-5. Also, the MCS selector 105 selects the MCS acquired from CQI_{ADJ} supplied from the CQI reproduction part 94 if the information concerning the transmission permission before for the time T₂, which is supplied from the control signal decoder 104, indicates the transmission permission. The MCS selector 105 selects the MCS extracted by the control signal decoder 104 if the information indicates the transmission non-permission. Then, the MCS selector 105 supplies the selected MCS to the data demodulator 70 and the error correction decoder 71.

The channel compensator 69 conducts the channel compensation by using the CSI provided from the channel estimator 91 with respect to the received data signal supplied from the channel separator 91. The data demodulator 70 conducts the data demodulation in accordance with the modulation method indicated by the MCS provided from the MCS selector 105. The error correction decoder 71 conducts the error correction decoding for demodulated data received from the data demodulator 70, by using the coding rate indicated by the MCS supplied from the MCS selector 105, thereby reproducing the information bits. Then, the information bits are output from the error correction decoder 71.

The control signal generator 103 selects the uplink shared channel PUSCH when determining that a transmission is permitted based on the information concerning the transmission permission of the uplink data, the information being extracted by and supplied from the control signal decoder 104. The control signal generator 103 selects the uplink control channel PUCCH when determining that the transmission is not permitted based on the information concerning the transmission permission of the uplink data. After selecting one of the uplink shared channel PUSCH and the uplink control channel PUCCH, the control signal generator 103 generates the control signal by conducting the coding, the data modulation, and the like for the control information such as the CQI_{FB,1}, . . . , CQI_{FB,K} or the like provided from the CQI calculator 92. The RF transmitter 73 conducts the D/A conversion and the quadrature modulation for the control signal, converts from the baseband to the radio frequency, and sends a signal of the radio frequency to the transmission station 10-5.

As described above, in a case of generating CQI_{DIFF} based on the CQI_{FB} transmitted via the uplink shared channel PUSCH, even if the number of the information bits is reduced, it is possible for the receiving station 30-5 to recognize the MCS and decode the data signal.

According to the above described embodiments, it is possible to reduce the control bits and improve the transmission efficiency of the data signal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A modulation switching method performed in a radio communication system in which a modulation method for modulating a data signal is determined and switched based on first channel quality information fed back from a receiving station, and switch information for switching the modulation method of the data signal is sent from a transmission station to the receiving station, the modulation switching method comprising:
generating, with the transmission station, difference information between the first channel quality information fed back from the receiving station and second channel quality information used to determine the modulation method;
sending, with the transmission station, the difference information as control information to the receiving station;
acquiring, with the receiving station, the switch information from the difference information received as the control information and third channel quality information being previous information in the receiving station; and
demodulating, with the receiving station, the data signal based on the switch information.

2. The modulation switching method according to claim 1,
wherein when the first channel quality information is fed back in which an error detection code is additionally provided by the receiving station,
the transmission station generates the difference information between the first channel quality information fed back from the receiving station and the second channel quality information used to determine the modulation method; and
sends the difference information as the control information to the receiving station, and
when the first channel quality information is fed back in which the error detection code is not additionally provided by the receiving station, the transmission station sends the switch information as the control information to the receiving station; and
wherein when the difference information is received as the control information, the receiving station acquires the switch information from the difference information received from the transmission station and the third channel quality information being the previous information in the receiving station; and
when the switch information is received as the control information, the receiving station extracts the switch information from the control information received from the transmission station.

3. The modulation switching method according to claim 1,
wherein the channel quality information is defined for each of frequency sub-bands,
wherein the transmission station
averages the first channel quality information of the frequency sub-bands fed back from the receiving station for one or more frequency sub-bands being allocated for a data transmission;
generates the difference information between the first channel quality information, which is fed back from the receiving station and is averaged, and the second channel quality information used to determine the modulation method; and
sends the difference information as the control information to the receiving station; and
wherein the receiving station acquires the switch information based on the difference information received as the control information and an average value of fourth channel quality information for the frequency sub-bands allocated for the data transmission in the third channel quality information being previous information respective to each of the frequency sub-bands.

4. A transmission station for determining and switching a modulation method for modulating a data signal based on first channel quality information fed back from a receiving station, and sending switch information for switching the modulation method of the data signal to the receiving station, in a radio communication system, the transmission station comprising:
a receiver configured to receive the first channel quality information fed back from the receiving station; and
a transmitter configured to transmit difference information between the first channel quality information received by the channel quality information receiver and second channel quality information used to determine the modulation method, as control information to the receiving station.

5. A receiving station for feeding back first channel quality information to a transmission station and receiving switch information of a modulation method of data signal from the transmission station, the modulation method being determined and switched by the transmission station based on the first channel quality information, in a radio communication system, the receiving station comprising:
a transmitter configured to generate the first channel quality information of a radio channel via which the data signal is received, and to send the first channel quality information to the transmission station; and
a switch information acquisition part configured to acquire the switch information based on difference information and third channel quality information being previous information in the receiving station, in which the difference information between second channel quality information used to determine the modulation method and the first channel quality information fed back from the receiving station is received from the transmission station as the control information.

6. The transmission station according to claim 4, wherein the transmitter transmits the difference information, between the first channel quality information received by the receiver and the second channel quality information used to determine the modulation method, as the control information to the receiving station, when the first channel quality information is fed back in which an error detection code is additionally provided by the receiving station, and send the switch information as the control information to the receiving station, when the first channel quality information is fed back in which the error detection code is not additionally provided by the receiving station.

7. The receiving station according to claim 5, wherein the switch information acquisition part configured to acquire the switch information from the difference information received from the transmission station and the third channel quality information being the previous information in the receiving station, when the difference information is received as the control information, and extract the switch information from the control information received from the transmission station, when the switch information is received as the control information.

8. The transmission station according to claim 4,
wherein the channel quality information is defined for each of frequency sub-bands, and comprises
control information generator configured to average the first channel quality information of the frequency sub-bands fed back from the receiving station for one or more frequency sub-bands being allocated for a data transmission, generate the difference information between the first channel quality information, which is fed back from the receiving station and is averaged, and the second channel quality information used to determine the modulation method, and
the transmitter transmits the difference information as the control information to the receiving station.

9. The receiving station as claimed in claim 5,
wherein the transmitter transmits first channel information generated for each of the frequency sub-bands of the radio channel via which the data signal is received, to the transmission station, and
the switch information acquisition part is configured to acquire the switch information based on the difference information received as the control information and an average value of fourth channel quality information for the frequency sub-bands allocated for the data transmission in the third channel quality information being previous information respective to each of the frequency sub-bands.
